(19) United States
(12) Patent Application Publication
(10) Pub. No.: US 2005/0024877 A1
(43) Pub. Date: Feb. 3, 2005

(54) Decorative light strings and repair device

(76) Inventor: W Richard Frederick, Mundelein, IL (US)

Correspondence Address: JENKENS & GILCHRIST, P.C., 225 WEST WASHINGTON, SUITE 2600, CHICAGO, IL, 60606, US

(21) Appl. No.: 10/479,010

(22) PCT Filed: Mar. 13, 2002
(86) PCT No.: PCT/US02/07609

Related U.S. Application Data
(63) Continuation-in-part of application No. 09/854,255, filed on May 14, 2001, now abandoned.
(63) Continuation-in-part of application No. 10/041,032, filed on Dec. 28, 2001, now Pat. No. 6,734,678.
(63) Continuation-in-part of application No. 10/068,452, filed on Feb. 6, 2002, now Pat. No. 6,561,673.
(60) Provisional application No. 60/277,346, filed on Mar. 19, 2001.
(60) Provisional application No. 60/277,481, filed on Mar. 20, 2001.
(60) Provisional application No. 60/287,162, filed on Apr. 27, 2001.
(60) Provisional application No. 60/289,865, filed on May 9, 2001.

(51) Int. Cl. F21S 2/00

(52) U.S. Cl. 362/277

(57) ABSTRACT

One or more strings of decorative lights are supplied with power by converting a standard residential electrical voltage to a low-voltage, and supplying the low-voltage to at least one pair of parallel conductors having multiple decorative lights connected to the conductors along the lengths thereof, each of the lights, or groups of the lights, being connected in parallel across the conductors. A repair device for fixing a malfunctioning shunt across a failed filament in a light bulb in a group of series-connected miniature decorative bulbs includes a high-voltage pulse generator producing one or more pulses of a magnitude greater than the standard AC power line voltage. A connector receives the pulses from the pulse generator and supplies them to the group of series-connected miniature decorative bulbs. The pulse generator may be a piezoelectric pulse generator, a battery-powered electronic pulse generator, and/or an AC-powered electrical pulse generator.

### CROSS-REFERENCE TO RELATED APPLICATIONS

This application is a continuation in part of PCT application PCT/US/02/07609 filed Mar. 13, 2002, claiming priority to U.S. provisional application 60/277,346 filed Mar. 19, 2001, 60/277,481 filed Mar. 20, 2001, 60/287,162 filed Apr. 27, 2001, 60/289,865 filed May 9, 2001, and U.S. application Ser. No. 09/854,255 filed May 14, 2001, Ser. No. 10/041,032 filed Dec. 28, 2001 and 10/068,452 filed Feb. 2, 2002.

### FIELD OF THE INVENTION

The present invention relates to decorative lights, including lights for Christmas trees, including pre-strung or “pre-lit” artificial trees.

### SUMMARY OF THE INVENTION

In accordance with the present invention, one or more strings of decorative lights are supplied with power by converting a standard residential electrical voltage to a low-voltage, and supplying the low-voltage to at least one pair of parallel conductors having multiple decorative lights connected to the conductors along the lengths thereof, each of the lights, or groups of the lights, being connected in parallel across the conductors. A string of decorative lights embodying this invention comprises a power supply having an input adapted for connection to a standard residential electrical power outlet, the power supply including circuitry for converting the standard residential voltage to a low-voltage output; a pair of conductors connected to the output of the power supply for supplying the low-voltage output to multiple decorative lights; and multiple lights connected to the conductors along the lengths thereof, each of the lights, or groups of the lights, being connected in parallel across the conductors. The lights preferably require voltages of about 6 volts or less, and are preferably connected in parallel groups of 2 to 5 lights per group with the lights within each group being connected in series with each other.

The parallel groups are useful for current management. Light strings typically have 100 bulbs, and 100 6-volt bulbs drawing 80 ma./bulb in parallel requires a total current flow of 8 amps, which requires relatively thick wires. With the series/parallel groups, the total current and the wire size can both be reduced.

In one particular embodiment, a low-voltage DC power supply is used in combination with a string having dual-bulb sockets and associated diode pairs to permit different decorative lighting effects to be achieved by simply reversing the direction of current flow in the string, by changing the orientation of the string plug relative to the power supply.

Another aspect of the invention is to provide spare-part storage as an integral part of the light string, so that failed bulbs and fuses can be easily and quickly replaced with a minimum of effort. Improved bulb removal devices are also provided to further facilitate bulb replacement.

In accordance with another aspect of the present invention, there is provided a repair device for fixing a malfunctioning shunt across a failed filament in a light bulb in a group of series-connected miniature decorative bulbs. The device includes a high-voltage pulse generator producing one or more pulses of a magnitude greater than the standard AC power line voltage. A connector receives the pulses from the pulse generator and supplies them to the group of series-connected miniature decorative bulbs. The pulse generator may be a piezoelectric pulse generator, a battery-powered electronic pulse generator, and/or an AC-powered electrical pulse generator.

The group of series-connected miniature decorative bulbs is typically all or part of a light string that includes wires connecting the bulbs to each other and conducting electrical power to the bulbs. The repair device preferably includes a probe for sensing the strength of the AC electrostatic field around a portion of the wires adjacent to the probe and producing an electrical signal representing the field strength. An electrical detector receives the signal and detects a change in the signal that corresponds to a change in the strength of the AC electrostatic field in the vicinity of a failed bulb. The detector produces an output signal when such a change is detected, and a signaling device connected to the detector produces a visible and/or audible signal when the output signal is produced to indicate that the probe is in the vicinity of a failed bulb. The failed bulb can then be identified and replaced.

The repair device is preferably made in the form of a portable tool with a housing that forms at least one storage compartment so that replacement bulbs and fuses can be stored directly in the repair device. The storage compartment preferably includes multiple cavities so that fuses and bulbs of different voltage ratings and sizes can be stored separated from each other, to permit easy and safe identification of desired replacement components.

The housing also includes a bulb test socket connected to an electrical power source within the portable tool to facilitate bulb testing. A functioning bulb inserted into the socket is illuminated, while non-functioning bulbs are not illuminated. A similar test socket may be provided for fuses, with an indicator light signaling whether a fuse is good or bad.

### BRIEF DESCRIPTION OF THE DRAWINGS

The invention may best be understood by reference to the following description taken in conjunction with the accompanying drawings, in which:

FIG. 1 is a schematic diagram of a string of decorative lights embodying the present invention;

FIG. 2 is a more detailed diagram of the light string shown in FIG. 1;

FIG. 3 is an enlarged and more detailed perspective view of a portion of the light string of FIG. 2;

FIG. 4 is an exploded perspective view of a bulb and socket for use in the light string of FIGS. 1-3;

FIG. 5 is a schematic circuit diagram of a suitable power supply for use in the light string of FIGS. 1-3;

FIG. 6 is a front elevation of a power supply for supplying multiple light strings on a prelit artificial tree;

FIG. 7 is a side elevation of the power supply of FIG. 6;

FIG. 8 is a top plan view of the power supply of FIG. 6;

FIG. 9 is an exploded perspective view of a modified bulb and socket for use in the light string of FIGS. 1-3;

FIG. 9a is a schematic circuit diagram of a reversible DC power supply for use with the modified bulb and socket shown in FIG. 9;

FIG. 10 is an exploded perspective view of another modified bulb and socket for use in the light string of FIGS. 1-3;

FIG. 11 is an exploded view of the bulb and socket shown in FIG. 10;

FIG. 12 is a perspective view of a tool for removing a failed bulb to be replaced;

FIG. 13 is a side elevation of the tool of FIG. 12 being used to loosen a bulb from its socket;

FIG. 14 is a side elevation of the tool of FIG. 12 being used to pry a bulb out of its socket;

FIG. 15 is a schematic circuit diagram of a modified power supply for use with the light string of FIGS. 1-3;

FIG. 16 is a perspective view of a power supply housing mounted on a prelit artificial tree for supplying power to multiple light strings on the tree;

FIG. 17 is a perspective view of a decorative light string embodying the invention;

FIG. 18 is a top view of the electrical plug included in the light string of FIG. 17;

FIG. 19 as a left end view of the electrical plug of FIGS. 17 and 18;

FIG. 20 is a side elevation view of the electrical plug of FIGS. 17 and 18;

FIG. 21 is a left end view of a first alternative embodiment of an electrical plug in which a semi-circular lamp remover is formed in the body of the plug;

FIG. 22 is a left end view of a second alternative embodiment of an electrical plug in which the body of the plug and the cover form a circular lamp remover;

FIG. 23 is a left end view of a third alternative embodiment of an electrical plug in which the cover is slidably retained in channels on the body of the plug;

FIG. 24 is a side elevation view of a fourth alternative embodiment of an electrical plug in which the compartment is a separate component that is attached to a conventional electrical plug;

FIG. 25 is a side elevation view of another alternative embodiment in which the compartment is attached to a receptacle instead of a plug;

FIG. 26 is a plan view of another alternative embodiment of a storage compartment that can be attached to a plug, receptacle or wires of a light string;

FIG. 27 is a plan view of a modified version of the embodiment of FIG. 26 in which the storage compartment accommodates two tiers of replacement components;

FIG. 28 is a side elevation of the storage compartment of FIG. 27 and a light-string plug to which the storage compartment is attachable;

FIG. 29 is a bottom perspective view of the storage compartment shown in FIG. 28;

FIG. 30 is a schematic diagram of a string of decorative lights being plugged into a repair device embodying the present invention, with the repair device shown in side elevation with a portion of the housing broken away to show the internal structure, portions of which are also shown in section;

FIG. 31 is a cross-sectional side view of a modified repair device embodying the invention;

FIG. 32 is a full side elevation of the device of FIG. 31, and illustrating a bulb being tested;

FIG. 33a is a top plan view of the tool built into the tip of the device of FIG. 31, for assisting the removal of a failed bulb from a light string;

FIG. 33b is a left end elevation of the tool shown in FIG. 33a;

FIG. 33c is a section taken along line 33c-33c in FIG. 33a;

FIG. 33d is a right end elevation of the tool shown in FIG. 33a;

FIG. 33e is a side elevation of the tool shown in FIG. 33a;

FIG. 33f is a top plan view of the tool shown in FIG. 33a and a light bulb, illustrating the use of the smaller arcuate recess to pry the bulb from its socket;

FIG. 33g is a top plan view of the tool shown in FIG. 33a and a light bulb, illustrating the use of the larger arcuate recess to pry the bulb from its socket;

FIG. 33h illustrates a cross-sectional view of the tool shown in FIG. 33a and a light bulb, illustrating the use of the aperture in the tool to remove the light bulb from its socket;

FIG. 34 is schematic circuit diagram of a piezoelectric high-voltage pulse source, dual sensitivity electrostatic field detector, bulb tester, fuse tester and continuity detector for use in the device of FIGS. 30-33;

FIG. 35 is a schematic diagram of a battery-powered circuit for generating high-voltage pulses in the device of FIGS. 30-33;

FIG. 36a is a schematic diagram of a simplified version of the circuit of FIG. 34 for detecting failed bulbs;

FIG. 36b is a schematic diagram of a power source and bulb tester for use with the circuit of FIG. 36a;

FIG. 37a is a block diagram of a modified circuit for detecting failed bulbs;

FIG. 37b is a schematic diagram of a circuit for implementing the block diagram of FIG. 37a;

FIG. 38 is a schematic diagram of an alternative battery-powered circuit for generating high-voltage pulses;

FIG. 39 is a schematic diagram of another alternative battery-powered circuit for generating high-voltage pulses;

FIG. 40 is a schematic diagram of yet another alternative circuit for generating high-voltage pulses, using power from a standard AC outlet;

FIG. 41 is a schematic diagram of another alternative battery-powered circuit for generating high-voltage pulses;

FIG. 42 is a schematic diagram of an AC source for generating high-voltage pulses;

FIG. 43 is a schematic diagram of another alternative circuit for generating high-voltage pulses, using power from a standard AC outlet;

FIG. 44 is a front perspective view of another modified repair device embodying the invention;

FIG. 45 is a back perspective view of the embodiment shown in FIG. 44;

FIG. 46a is a right side elevation of the embodiment shown in FIGS. 44 and 45;

FIG. 46b is a front elevation of the embodiment shown in FIG. 46a;

FIG. 47a is a left side elevation with a partial cutout exposing some of the internal parts of the embodiment shown in FIGS. 44-46;

FIG. 47b is a back elevation of the embodiment shown in FIG. 47a;

FIG. 48a is a top plan view of the embodiment shown in FIGS. 44-47;

FIG. 48b is a bottom plan view of the embodiment shown in FIGS. 44-47;

FIG. 49a is a right side elevation of the embodiment shown in FIGS. 44-47, with the storage compartment cover removed;

FIG. 49b is a plan view of the interior surface of the cover removed from the device as shown in FIG. 49a;

FIG. 50 is a side elevation of the battery-containing and switch-actuating element of the embodiment shown in FIGS. 44-47;

FIG. 51a is an exploded right side elevation of the left-hand and upper segments of the body portion of the embodiment shown in FIGS. 44-47;

FIG. 51b is a side elevation of the trigger element of the embodiment shown in FIGS. 44-47;

FIG. 52 is a top plan view of the embodiment shown in FIGS. 44-47, with a portion broken away to show the internal structure;

FIGS. 53-54 are the actual shapes of pulses produced by pulse-generating devices for use in repair devices embodying the invention; and

FIG. 55 is a schematic circuit diagram of a modified power supply for use with the light string of FIGS. 1-3.

### DETAILED DESCRIPTION OF THE ILLUSTRATED EMBODIMENTS

Although the invention will be described next in connection with certain preferred embodiments, it will be understood that the invention is not limited to those particular embodiments. On the contrary, the description of the invention is intended to cover all alternatives, modifications, and equivalent arrangements as may be included within the spirit and scope of the invention as defined by the appended claims.

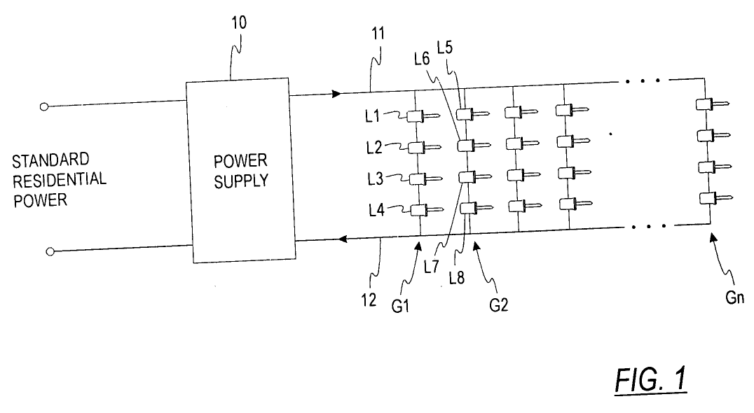

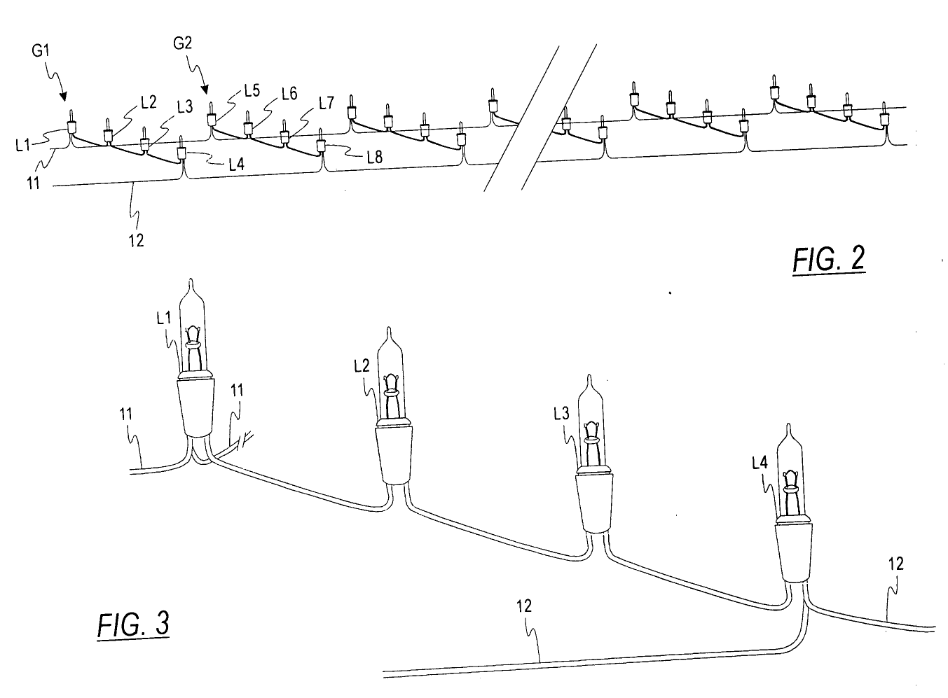

Turning now to the drawings and referring first to FIGS. 1-3, a power supply 10 is connected to a standard residential power outlet that supplies electrical power at a known voltage and frequency. In the United States, the known voltage is 120 volts and the frequency is 60 Hz, whereas in Europe and some other countries the voltage is 220-250 volts and the frequency is 50 Hz. The power supply 10 converts the standard power signal to a 24-volt, 30-KHz pulse width modulated waveform (PWM), which is supplied to a pair of parallel conductors 11 and 12 that supply power to multiple 6-volt incandescent lights L. A typical light “string” contains 100 lights L.

Multiple groups of the lights L are connected across the two conductors 11 and 12, with the lights within each group being connected in series with each other, and with the light groups in parallel with each other. For example, lights L1-L4 are connected in series to form a first light group G1 connected across the parallel conductors 11 and 12, lights L5-L8 are connected in series to form a second group G2 connected across the conductors 11 and 12 in parallel with the first group G1, and so on to the last light group Gn.

If one of the bulbs fails, the group of four series-connected lights containing that bulb will be extinguished, but all the other 96 lights in the other groups will remain illuminated because their power-supply circuit is not interrupted by the failed bulb. Thus, the failed bulb can be easily and quickly located and replaced. Moreover, there is no need for shunts to bypass failed bulbs, which is a cost saving in the manufacture of the bulbs. If it is desired to avoid extinguishing all the lights in a series-connected group when one of those lights fails, then the lights may still be provided with shunts that are responsive to the low-voltage output of the power supply. That is, each shunt is inoperative unless and until it is subjected to substantially the full output voltage of the power supply, but when the filament associated with a shunt fails, that shunt is subjected to the full output voltage, which renders that shunt operative to bypass the failed filament. A variety of different shunt structures and materials are well known in the industry, such as those described in U.S. Pat. Nos. 4,340,841 and 4,808,885.

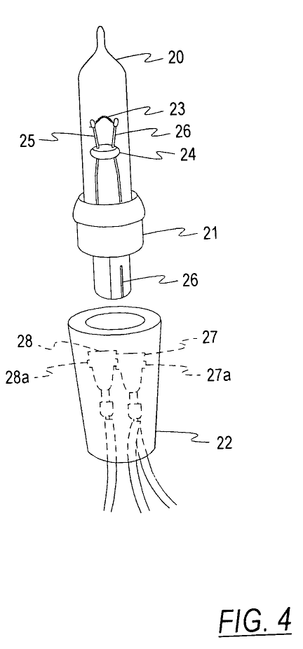

As shown in FIG. 4, each of the individual lights L uses a conventional incandescent bulb 20 attached to a plastic base 21 adapted to be inserted into a plastic socket 22 attached to the wires that supply power to the bulb. Each bulb contains a filament 23 that is held in place by a pair of filament leads 25 and 26 extending downwardly through a glass bead 24 and a central aperture in the base 21. The lower ends of the leads 25, 26 are bent in opposite directions around the lower end of the base 21 and folded against opposite sides of the base to engage mating contacts 27 and 28 in the socket 22. The interior of the socket 22 has a shape complementary to the exterior shape of the lower portion of the bulb base 21 so that the two components fit snugly together.

As shown most clearly in FIG. 4, the contacts 27 and 28 in each bulb base 22 are formed by tabs attached to stripped end portions of the multiple wire segments that connect the lights L in the desired configuration. These wire segments include multiple segments of the conductors 11 and 12 from FIGS. 1-3. As can be seen in FIG. 4, the connector tabs 27, 28 in each socket 22 are fed up through a hole in the socket and seated in slots formed in the interior surface of the socket on opposite sides of the hole. Prongs 27a and 28a on the sides of the tabs engage the plastic walls of the slots to hold the tabs securely in place within the slots. When the bulb base 21 is inserted into its socket 22, the bent filament leads 25, 26 on opposite sides of the bulb base 21 are pressed into firm contact with the mating tabs 27, 28.

As can be most clearly seen at the lower right-hand corner of FIG. 4, the tab 27 at each end of each series-connected group G is connected to two wires, one of which is a segment of one of the conductors 11 and 12, and the other of which leads to the next light in that particular series-connected group G.

After all the connections have been made, the wires are twisted or wrapped together as in conventional light sets in which all the lights are connected in series.

Turning next to the power supply 10 (shown in FIG. 1), a switching power supply is preferred to minimize size and heat. Power supplies of this type generally use switching technology to make the device smaller. An alternative is a power supply that uses switching technology and pulse width modulation or frequency modulation for output regulation, although this type of power supply is generally more expensive than those using electronic transformers. One suitable electronic transformer is available from ELCO Lighting of Los Angeles, Calif., Cat. No. ETR150, which converts a 12-volt, 60-Hz input into a 12-volt, 30-KHz output.

FIG. 5 is a generalized schematic diagram of a power supply for converting a standard 120-volt, 60-Hz input at terminals 30 and 31 into a 24-volt AC output at terminals 32 and 33. It will be understood that devices for supplying low-voltage, high-frequency signals are well known and vary to some degree depending on the output wattage range of the supply, and the particular design of the device is not part of the present invention. FIG. 5 illustrates a standard self-oscillating half-bridge circuit in which two transistors Q1 and Q2 and parallel diodes D10 and D11 form the active side of the bridge, and two capacitors C1 and C2 and parallel resistors R11 and R12 form the passive side.

The AC input from terminals 30 and 31 is supplied through a fuse F1 to a diode bridge 34 consisting of diodes D1-D4 to produce a full-wave rectified output across busses 35 and 36 leading to the transistors Q1, Q2 and the capacitors C1, C2. The capacitors C1, C2 form a voltage divider, and one end of the primary winding T1a of an output transformer T1 is connected to a point between the two capacitors. The secondary winding T1b of the output transformer is connected to the output terminals 32, 33, which are typically part of a socket for receiving one or more plugs on the ends of light strings. The resistors R11 and R12 are connected in parallel with the capacitors C1 and C2 to equalize the voltages across the two capacitors, and also to provide a current bleed-off path for the capacitors in the event of a malfunction or a blown fuse.

When power is supplied to the circuit, a capacitor C3 begins charging to the input voltage through a diode D5. A diac D6 and a current-limiting resistor R1 are connected in series from a point between the capacitor C3 and the diode D5 to the base of the transistor Q2. When the capacitor C3 charges to the trigger voltage of the diac D6, the capacitor C3 discharges, supplying current to the base of the transistor Q2 and turning on that transistor. A diode D7 avoids any circuit imbalance between the drive of Q1 and Q2 when the converter is in the steady-state mode, by preventing the capacitor from discharging and the diac from triggering. A resistor R2 limits the current from the buss 35. Resistors R3 and R4 connected to the bases of the respective transistors Q1 and Q2 stabilize the biases, and diodes D8 and D9 in parallel with the respective resistors R3 and R4 provide for fast turn off.

Self-oscillation of the illustrative circuit is provided by an oscillator transformer T2 having a saturable core. A ferrite core having a B/H curve as square as possible is preferred to provide a reliable saturation point. The number of turns in the primary and secondary windings T2a and T2b of the transformer T2 are selected to force the operating gain of the transistors Q1 and Q2, based on the following equation:
Nₚ*Iₚ−Nₛ*Iₛ
where Nₚ is the number of turns in the primary winding T2a, Nₛ, is the number of turns in the secondary winding T2b, Iₚ is the peak collector current, and Iₛ is the base current. Suitable values for Nₚ and Nₛ, are 1 and 3, respectively, and assuming a one-volt supply across the primary winding Nₚ, the forced gain is 3. The nominal collector current I_{c}, is:
I_{c}=(Pₒᵤₜ/η)*(2/Vₗᵢₙₑ)
where Pₒᵤₜ and Vₗᵢₙₑ are RMS values, and η is the efficiency of the output transformer T1.

The saturable transformer T2 determines the oscillation frequency F according to the following equation:
F=(Vₚ*10⁴)/(4*Bₛ*A*Nₚ)
where F is the chopper frequency, Vₚ is the voltage across the primary winding T2a of the oscillator transformer T2 in volts, Bₛ is the core saturation flux in Tesla, and A is the core cross section in cm².

The output transformer T1 has a non-saturable core with a ratio Nₚ/Nₛ, to meet the output requirements, such as 24 volts (RMS). It must also meet the power requirements so that it may operate efficiently and safely. The voltage across the primary winding T1a is the peak-to-peak rectified voltage Vₚₑₐₖ:
Vₚₑₐₖ=120*1.414=170 Vₚₑₐₖ
The desired 24-volt output translates to:
Vₚ₋ₚ=24*2*1.414=67.8 Vₚ₋ₚ
Thus, the required ratio of turns in the primary and secondary windings of the transformer T1 is 170/67.8 or 2.5/1.

A third winding T1c with a turns ratio of 10/1 with respect to the primary winding provides a nominal 6-volt output for a bulb checker, described below.

The illustrative circuit also includes a light dimming feature. Thus, a switch S1 permits the output from the secondary winding T1b to be taken across all the turns of that winding or across only a portion of the turns, from a center tap 37. A pair of thermistors RT1 and RT2 are provided in the two leads from the secondary winding T1b to the terminals 32 and 33 to limit inrush current during startup.

To automatically shut down the circuit in the event of a short circuit across the output terminals 32 and 33, a transistor Q3 is connected to ground from a point between the resistor R1 and the capacitor C3. The transistor Q3 is normally off, but is turned on in response to a current level through resistor R13 that indicates a short circuit. The resistor R13 is connected in series with the emitter-collector circuits of the two transistors Q1 and Q2, and is connected to the base of the transistor Q3 via resistors R14 and R15, a diode D12, and capacitor C4. The current in the emitter-collector circuit of transistors Q1 and Q2 rises rapidly in the event of a short circuit across the output terminals 32, 33. When this current flow through resistor R13 rises to a level that causes the diode D12 to conduct, the transistor Q3 is turned on, thereby disabling the entire power supply circuit.

The light string is preferably designed so that the load on the power supply remains fixed so that there is no need to include voltage-control circuitry in the power supply to maintain a constant voltage with variable loads. For example, the light string preferably does not include a plug or receptacle to permit multiple strings to be connected together in series, end-to-end. Multiple strings may be supplied from a single power supply by simply connecting each string directly to the power supply output via parallel outlet sockets. Extra lengths of wire may be provided between the power supply and the first light group of each string to permit different strings to be located on different portions of a tree. Because ripple is insignificant in decorative lighting applications, circuitry to eliminate or control such fluctuations is not necessary, thereby reducing the size and cost of the power supply.

The low-voltage output of the power supply may have a voltage level other than 24 volts, but it is preferably no greater than the 42.4 peak voltage specified in the UL standard UL1950, SELV (Safe Extra-Low Voltage). With a 30-volt supply, for example, 10-volt lights may be used in groups of three, or 6-volt lights may be used in groups of five. Other suitable supply voltages are 6 and 12 volts, although the number of lights should be reduced when these lower output voltages are used.

The power supply may produce either a DC output or low-voltage AC outputs. The frequency of a low-voltage AC output is preferably in the range from about 10 KHz to about 150 KHz within a 60 Hz envelope to permit the use of relatively small and low-cost transformers.

The voltage across each light must be kept low to minimize the complexity and cost of the light bulb and its socket. Six-volt bulbs are currently in mass production and can be purchased at a low cost per bulb, especially in large numbers. These bulbs are small and simple to install, and the low voltage permits the use of thin wire and inexpensive sockets, as well as minimizing the current in the main conductors. In the illustrative light string of FIG. 1 with a 24-volt supply and four lights per group, the voltage available for each light is 6 volts. Consequently, the bulbs can be the simple and inexpensive bulbs that are mass produced for conventional Christmas light strings using series-connected lights. Similarly, the simple and inexpensive sockets used in such conventional Christmas light strings can also be used. Simple crimped electrical contacts may be provided at regular intervals along the lengths of the parallel conductors 11 and 12 for connection to the end sockets in each group of four lights. The maximum current level is only about 2 amperes in a 100-light string using four 6-volt lights per group and a 24-volt supply, and thus the two conductors 11 and 12 can also be light, thin, and inexpensive.

Light strings embodying the present invention are particularly useful when used to pre-string artificial trees, such as Christmas trees. Such trees can contain well over 1000 lights and can cost several hundred dollars (US) at the retail level. When a single light and its shunt fail in a series light string, the lights in an entire section of the tree can be extinguished, causing customer dissatisfaction and often return of the tree for repair or replacement pursuant to a warranty claim. When the artificial tree is made in sections that are assembled by the consumer, only the malfunctioning section need be returned, but the cost to the warrantor is nevertheless substantial. With the light string of the present invention, however, the only lights that are extinguished when a single light fails are the lights in the same series-connected group as the failed light. Since this group includes only a few lights, typically 2 to 5 lights, the failed bulb can be easily located and replaced.

When pre-stringing artificial trees, the use of a single low-voltage power supply for multiple strings is particularly advantageous because it permits several hundred lights to be powered by a single supply. This greatly reduces the cost of the power supply per string, or per light, and permits an entire tree to be illuminated with only a few power supplies, or even a single power supply, depending on the number of lights applied to the tree.

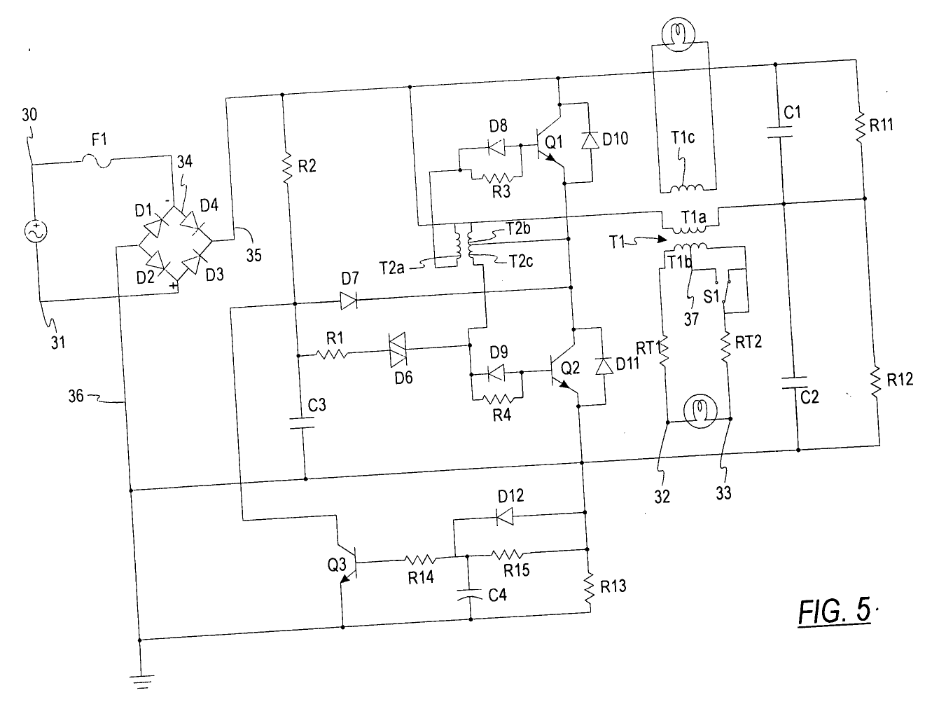

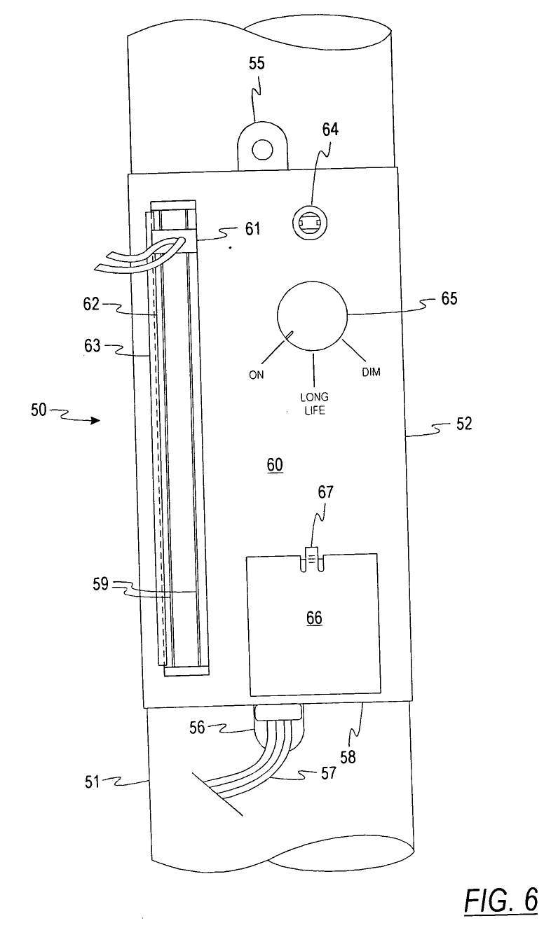

FIGS. 6-8 illustrate a single power supply 50 for supplying power to a multiplicity of light strings on a prelit artificial tree having a hollow artificial trunk 51. The power supply is contained in a housing 52 having a concave recess 53 in its rear wall 54 to mate with the outer surface of the artificial trunk 51. A pair of apertured mounting tabs 55 and 56 are provided at opposite ends of the rear wall 54 to permit the power supply to be fastened to the trunk 51 with a pair of screws. The power input to the supply 50 is provided by a conventional three-conductor cord 57 that enters the housing through the bottom wall 58. The free end of the cord 57 terminates in a standard three-prong plug.

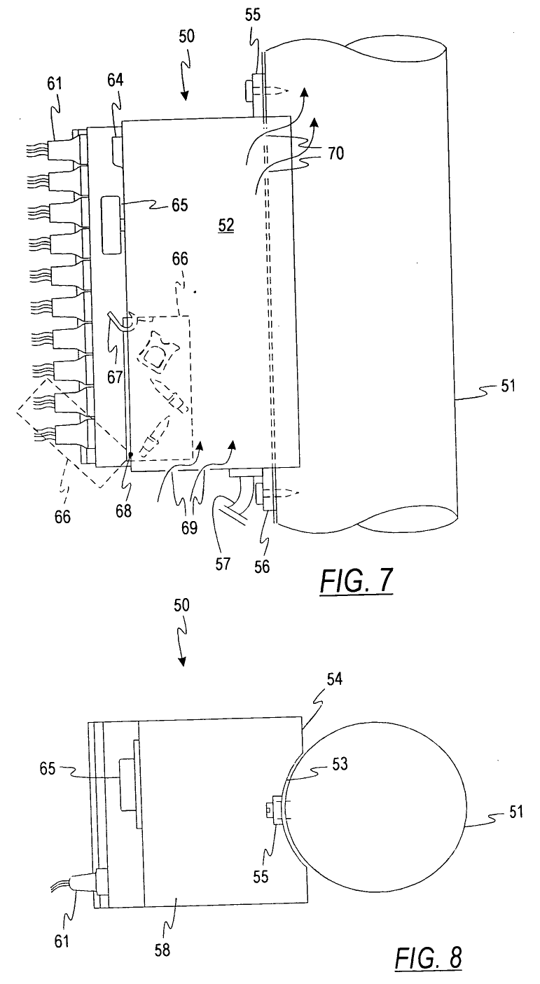

The power output of the supply 50 is accessible from a terminal strip 59 mounted in a vertically elongated slot 60 in the front wall of the housing 52. This terminal strip 59 can receive a multiplicity of plugs 61 on the ends of a multiplicity of different light strings, as illustrated in FIG. 7. Thus, if each light string contains 100 lights and the terminal strip can receive ten plugs, the power supply can accommodate a total of 1000 lights for a given tree. Each plug 61 is designed to fit the terminal strip 59 but not standard electrical outlets, to avoid accidental attachment of the low-voltage light string to a 120-volt power source. A latch 62 extends along one elongated edge of the terminal strip 59 to engage each plug 61 as it is inserted into the strip, to hold the plugs in place. When it is desired to remove one of the plugs 61, a release tab 63 is pressed to tilt the latch enough to release the plug.

The front wall of the power supply 50 also includes a bulb-testing socket 64 containing a pair of electrical contacts positioned to make contact with the exposed filament leads on a 6-volt bulb when it is inserted into the socket 64. The contacts in the socket 64 are connected to a 6-volt power source derived from the power-supply circuit within the housing 52, so that a good bulb will be illuminated when inserted into the socket 64.

If desired, dimmer, flicker, long-life and other operating modes can be provided by the addition of minor circuitry to the power supply. In the illustrative power supply 50, a selector switch 65 is provided on the front of the housing 52 to permit manual selection of such optional modes.

The front wall 60 of the housing 52 further includes an integrated storage compartment 66 for storage of spare parts such as bulbs, tools and/or fuses. This storage compartment 66 can be molded as a single unit that can be simply pressed into place between flanges extending inwardly from the edges of an aperture in the front wall 60 of the housing 52. The flange on the top edge of the aperture engages a slightly flexible latch 67 formed as an integral part of the upper front corner of the storage compartment 66. The lower front corner of the compartment and the adjacent flanges form detents 68 that function as pivot points to allow the storage compartment 66 to be pivoted in and out of the housing 52, as illustrated in FIG. 7, exposing the open upper end of the storage compartment.

As can be seen in FIG. 7, the bottom and rear walls 58 and 54 of the housing 52 are preferably provided with respective holes 69 and 70 that allow air to flow by convection through the housing to provide airflow desired of the circuit elements within the housing.

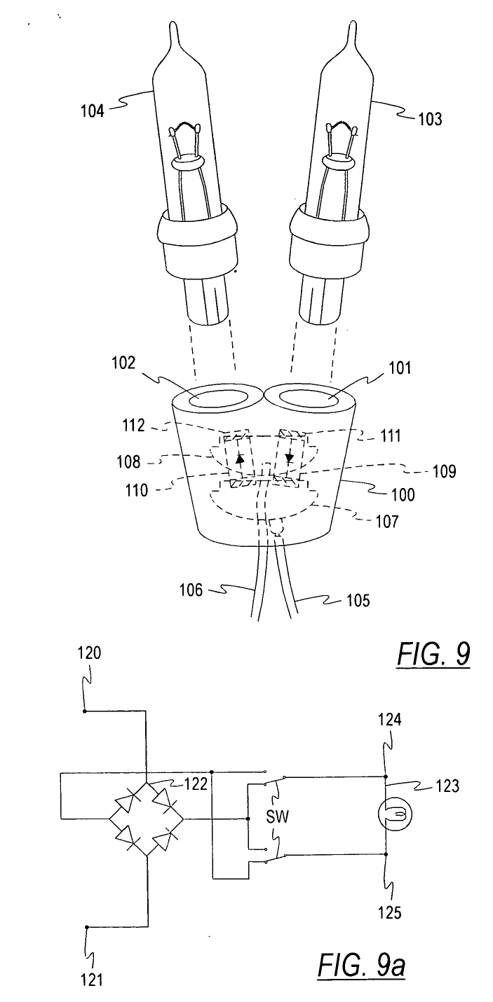

FIG. 9 illustrates a modified bulb-socket construction for use with a low-voltage DC power supply. A DC power supply may be the same device described above with the addition of a full-wave rectifier at the output to convert the low-voltage, high-frequency voltage to a low-voltage, DC voltage. The plug on the light string to be connected to the DC power supply is reversible so that the plug may be inserted into the socket of the power supply in either of two orientations, which will cause the DC current to flow through the light string in either of two directions. As will be described in more detail below, the direction of the current flow determines which of two bulbs in each of the multiple sockets along the length of the string are illuminated. This permits different decorative effects to be achieved with the same string by simply reversing the orientation of the string plug relative to the power-supply socket. For example, the bulbs illuminated by current flow in one direction may be clear bulbs, while the bulbs illuminated by current flow in the opposite direction may be colored and/or flashing bulbs.

As can be seen in FIG. 9, each socket 100 forms receptacles 101 and 102 for two different bulbs 103 and 104, respectively. For example, bulb 103 may be clear and bulb 104 colored. Power is delivered to both receptacles 101 and 102 by the same pair of wires 105 and 106, but the connector tabs 107 and 108 attached to the wires have increased widths to permit electrical connection to the exposed filament leads on the bases of both bulbs. The rear connector tab 108 makes direct contact with one of the filament leads on the base of each bulb. The front connector tab 107 carries a pair of inexpensive, oppositely poled, surface-mount diodes 109 and 110 having metallized contact surfaces 111 and 112 at their upper ends. Each of the metallized contact surfaces 111 and 112 makes contact with a filament lead on only one of the bulb bases, so that each diode 109 and 110 is connected to only one bulb. Because a diode conducts current in only one direction, and the two diodes are poled in opposite directions, the DC current supplied to the socket 100 will flow through only one of the two bulbs 103 or 104, depending upon the direction of the current flow, which in turn depends upon the orientation of the string plug relative to the power-supply socket.

As shown in FIG. 9, the two bulbs 103 and 104 preferably diverge from each other to reduce reflections from the non-illuminated bulb in each pair. If desired, a non-reflective barrier may be provided between the two bulbs.

A modified construction is to provide only a single pair of diodes for each of the parallel groups of lights. The diodes are provided at one end of each parallel group, with two separate wires connecting each diode to one of the two bulbs in each socket in that group.

Another modified construction uses only a single bulb in each socket, with each bulb having two filaments and two diodes integrated into the base of the bulb for controlling which filament receives power. The two filaments are spaced from each other along the axis of the bulb, and one end portion of the bulb is colored so that illumination of the filament within that portion of the bulb produces a colored light, while illumination of the other filament produces a clear light. Alternatively, the opposite end portions of the bulb can both be colored, but of two different colors.

FIG. 9a is a diagram of a circuit for reversing the polarity of a DC power supply. The standard AC power source is connected across a pair of input terminals 120 and 121 and full-wave rectified by a diode bridge 122 as described above. The rectified output of the bridge 122 is supplied to the light string 123 connected to output terminals 124 and 125. Between the bridge 122 and the terminals 124, 125, a dual pole switch SW can change the direction of current flow so that the polarity of the terminals 124 and 125 is reversed.

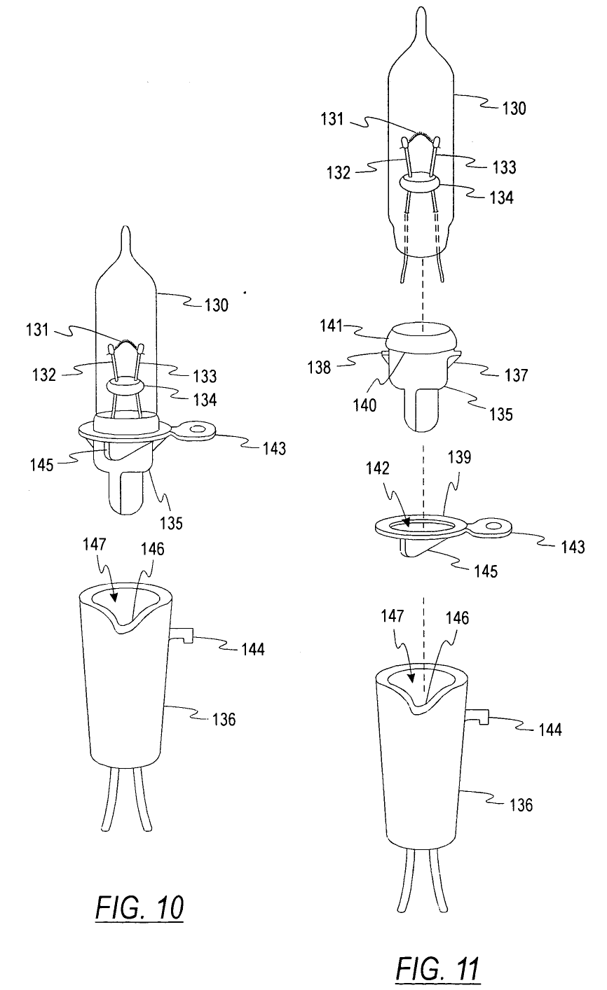

FIGS. 10 and 11 illustrate a modified bulb base and socket construction that facilitates the replacement of a failed bulb. The bulb 130 in FIGS. 10 and 11 has the same construction described above, including a filament 131 and a pair of filament leads 132 and 133 held in place by a glass bead 134. The leads 132 and 133 extend downwardly through a molded plastic base 135 that fits into a complementary socket 136. In this modified embodiment, the bulb base 135 includes a pair of diametrically opposed lugs 137 and 138 that support a bulb-removal ring 139 between the top surfaces of the lugs and the underside 140 of the flange 141 of the base 135. The central opening 142 of the ring 139 is dimensioned to have a diameter just slightly smaller than that of the flange 141 so that the ring can be forced upwardly over the lugs 137, 138 until the ring 139 snaps over the top surfaces of the lugs, adjacent the underside of the flange 141. The ring 139 is then captured on the base 135, but can still rotate relative to the base.

To hold the bulb base 135 in the socket 136, the ring 139 forms a hinged, apertured tab 143 that can be bent downwardly to fit over a latching element 144 formed on the outer surface of the socket 136. When the bulb fails, the tab 143 is pulled downwardly and away from the socket 136 to release it from the socket 136, and then the tab 143 is used to rotate the ring 139 to assist in removing the bulb and its base 135 from the socket 136. As the ring 139 is rotated, a descending ramp 145 molded as an integral part of the ring engages a ramp 146 formed by a complementary notch 147 in the upper end of the socket 136. When the bulb base 135 and the socket are initially assembled, the ramp 145 on the ring 139 nests in the complementary notch 147. But when the ring 139 is rotated relative to the socket 136, the engagement of the two ramps 145 and 146 forces the two parts away from each other, thereby lifting the bulb base 135 out of the socket 136.

It is common to purchase Christmas lights a few strings at a time, and new packages come with spare bulbs and fuses. However, as the light strings are used, the spare parts tend to become lost, and when they are needed they cannot be found, or it becomes difficult to determine which parts go with which string. Bulbs are made with a plethora of different bases, bulb voltages, etc. and replacing a burned-out bulb with a bulb of the correct voltage, correct base type, and correct amperage fuse, not only assures optimum performance but also can be a safety factor. Some light strings are so inexpensive that the entire string can simply be replaced when a bulb fails, but such re-purchases are further inconveniences. Failing to replace burned-out bulbs increases the voltage to the other bulbs, which shortens the life of the remaining bulbs and accelerates the problem.

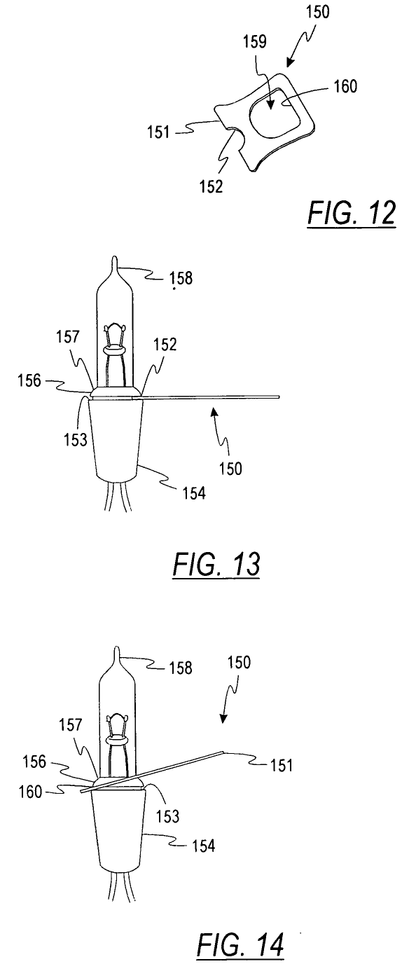

FIGS. 12-14 illustrate a separate bulb-removal tool 150 that can be packaged with the other spare parts for a light string. The bases and sockets of such bulbs are typically made to fit tightly together to ensure that the bulbs remain in their sockets and maintain the electrical connections that are made by a tight frictional fit within those sockets. As a result, when a bulb fails, it is often difficult to remove the burned-out bulb for replacement. The tool 150 has an elongated tapered edge 151 that forms a cutout 152 that can be pressed between the top surface 153 of a bulb socket 154 and the lower surface of a flange 156 on a bulb base 157. The tool can be tilted up and down, and pivoted back and forth horizontally, while being pressed between the flange 156 and the socket surface 153, to initially loosen the bulb base 157 in its socket 154 (see FIG. 13). The tool 150 can also be placed over the bulb 158, with the bulb extending upwardly through an opening 159 in the tool, and with the inner edge 160 of the opening 159 resting on the top surface 153 of the socket 154, as illustrated in FIG. 14. With the tool 150 in this position, the tool is pulled upwardly to pry the bulb base 157 out of the socket 154. The tool 150 may be made of metal or a rigid plastic.

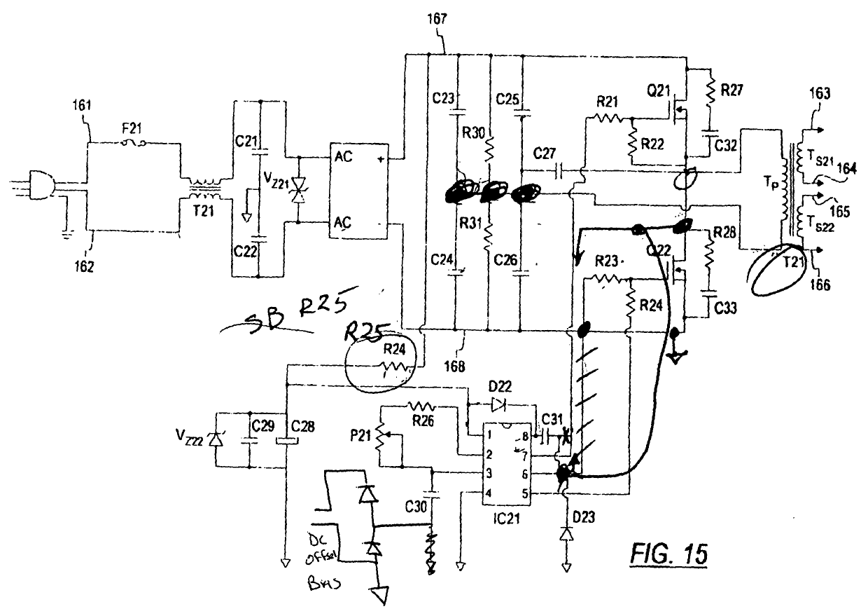

FIG. 15 is a generalized schematic diagram of a power supply for converting a standard 120-volt, 60-Hz input at terminals 161, 162 into a 24-volt AC output at terminals 163, 164 and 165, 166. This circuit uses a power switching supply to deliver a low-voltage, high-frequency PWM signal while also providing the following features for the light strings:
continuous dimming capability from very low light level to full light level,
multi-level dimming capability,
energy-saving and minimum-light-setting features,
soft-start feature to increase the lamp life,
soft start feature to reduce inrush current in the circuit, and
low cost with multi-feature lighting.

The AC input from the terminals 161, 162 is supplied through a fuse F21 to a diode bridge DB21 consisting of four diodes to produce a full-wave rectified output across buses 167 and 168, leading to a pair of capacitors C23 and C24 and a corresponding pair of transistors Q21 and Q22 forming a half bridge. The input to the diode bridge DB21 includes a dual zener diode V_{Z21} and a pair of capacitors C21 and C22 which are part of the radio frequency interference and line noise filtering circuitry. Capacitors C25 and C26 are connected in parallel with capacitors C23 and C24, respectively, to provide increased ripple current rating and high-frequency performance. The capacitors C23 and C24 may be electrolytic capacitors while capacitors C25 and C26 are film-type capacitors offering high-frequency characteristics to the parallel combination. A pair of resistors R30 and R31 are connected in parallel with the capacitors C23 and C24, respectively, to equalize the voltages across the two capacitors, and also to provide a current bleed-off path for the capacitors in the event of a malfunction or a blown fuse.

The capacitors C23, C24 form a voltage divider, and one end of the primary winding Tₚ of an output transformer T22 is connected to a point between the two capacitors. The secondary windings T_{S21}, and T_{S22} of the transformer T22 are connected to the output terminals 163, 164 and 165, 166, which are typically part of a socket for receiving one or more plugs on the ends of light strings. A capacitor C27 is connected in parallel with the primary winding Tₚ and acts as a snubber across the transformer T22 to reduce voltage ringing.

An integrated circuit driver IC21, such as a IR2153 driver available from International Rectifier, drives the half bridge MOSFET transistors Q21 and Q22. The power supply for the driver IC21 is derived from the DC bus through a resistor R25 and a parallel combination of capacitors C28 and C29. The capacitor C28 is preferably an electrolytic capacitor, and the capacitor C29 is preferably a film-type capacitor offering high-frequency de-coupling characteristic to the driver IC21. A zener diode V_{Z22} clamps the voltage across the V_{CC} of the supply to ensure a safe operating limit. The zener diode V_{Z22} along with the resistor R25 provide a regulated power supply for the driver IC21. A diode D22 and a capacitor C31 provide a boot-strap mechanism for power storage to turn on the MOSFET Q21 of the half bridge.

The frequency of oscillation of the MOSFET driver is determined by the total resistance connected across pins 2 and 3 of the driver IC21 and a capacitor C30 connected across pin 3 and ground of the driver IC21. The two outputs of the IC21 pins 7 and 5 are connected to the gates of the MOSFETs Q21 and Q22. A resistor R21 limits the gate current of the MOSFET Q21. A pair of resistors R22 and R24 are connected across the MOSFETs Q21 and Q22 to reduce noise sensitivity to avoid any spurious turn-on of the MOSFETs. Resistor/capacitor combinations R27/C32 and R28/C33 are tied across the two MOSFETs Q21 and Q22 as snubbers to quench transient voltage surges at the turn-off of these transistors.

When power is applied to the circuit, the voltage developed on the bus 167 causes voltage to be applied to the IC21 V_{CC}. This causes the driver IC21 to start oscillating and start driving the half-bridge transistors Q21 and Q22 alternately. This applies voltage across the primary winding Tₚ of the transformer T21, which in turn applies voltage across the secondary windings T_{S21} and T_{S22} of the transformer, which is applied to the load.

The rectified output of the DC bus 167 is applied is applied to the Vcc of the driver IC21 through a resistor R25. A zener diode V_{Z2} and capacitors C28 and C29 are connected across the Vcc pin 1 of the driver IC21. The zener diode V_{Z2} provides regulation to the voltage applied to the Vcc of the driver IC21. The two outputs of the IC21 pins 7 and 5 are connected to the gates of the MOSFETs Q21 and Q22.

The output voltage can be varied by controlling the on/off ratio of the pulse width applied to the primary of the transformer T22. A limited dimming control can be achieved by varying the frequency of the oscillation signal from the integrated circuit IC21. The output voltage is controlled by the potentiometer P1 connected to the integrated circuit, which permits the user to adjust the light output to the desired level.

The dimming feature can be used to provide different fixed light levels, such as a low light output, an energy-saving output, or a full-light output. These three light levels can be achieved by use of three fixed resistors in place of the potentiometer P1. The three resistor settings can be selected by use of a three-position switch. A low-light output corresponds to a minimum output voltage, and a full-light output corresponds to maximum output voltage. An energy-saving output corresponds to an intermediate light level such as a 75% light output.

The bulb life can be extended by soft starting the driver IC21, so that the IC starts with minimum light output and slowly ramps up to the full or desired light level. At the time of start, the bulbs in the light string are normally cold, and the cold resistance of the bulbs is very low. The cold resistance of a bulb is typically ten times lower than the steady state, full-light operating resistance. If the full voltage were applied to a cold bulb at startup, the inrush bulb current could be ten times the rated current of the bulb, which could cause the bulb filament to weaken and ultimately break. By soft starting the control circuit, the voltage applied during starting of the bulb is significantly lower. As the bulb heats up and the bulb resistance increases, the voltage is increased. Thus the bulb current never exceeds its hot rating, which increases bulb life.

Soft starting of the circuit also helps reduce the inrush current from the circuit, thereby avoiding any interaction with other circuits or appliances. Soft starting in this circuit can be achieved by starting the driver IC21 at high frequency and then reducing it to the desired operating point with a small delay e.g. one second. This could be accomplished in the circuit shown by adding a DC offset voltage to the ground return of capacitor C30. This offset could be generated either by a time delayed voltage source derived from Bus 167 or a feedback loop detecting the output current and maintaining a feedback voltage on C30 ground return keeping the output current constant.

If a wider range of dimming control is needed, the driver IC21 can be replaced by another integrated circuit, such as an IR21571, along with a PWM controller to drive the FETs, thereby providing a full range of pulse width modulation. The output can be controlled from almost zero light to full light.

The particular embodiment illustrated in FIG. 15 is a half bridge circuit as an example for but it will be understood that the features of this circuit can be incorporated in other topologies such as flyback, forward, cuk, full bridge or other power converters, including isolated as well as non-isolated power converter designs.

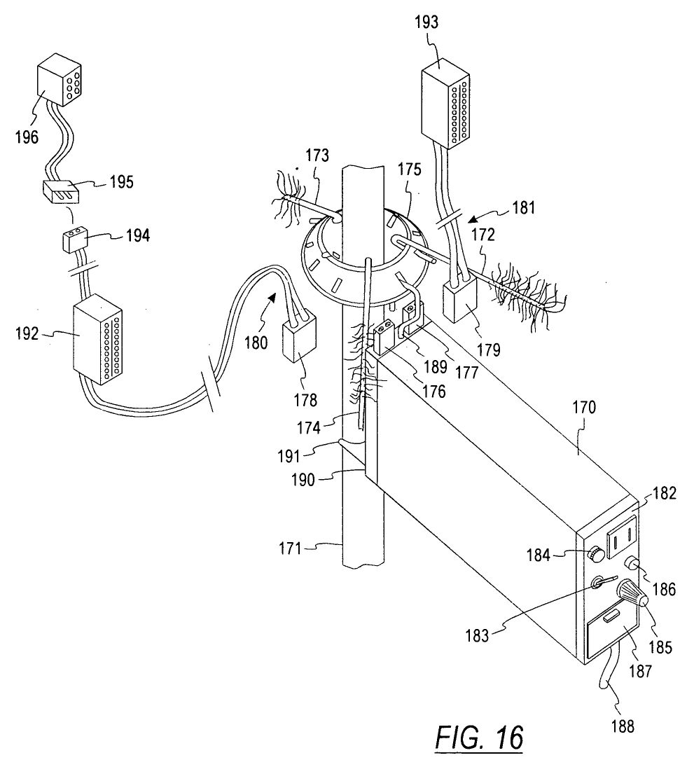

FIG. 16 illustrates a mounting arrangement for a housing 170 containing any of the power supplies described above, on a pre-lit artificial tree having a central “trunk” pole 171 and multiple branches such as branches 172-174 extending laterally from a support collar 175 on the pole 171. Each branch carries a portion of one of multiple light strings attached to connectors on the housing 170. In the illustrative embodiment, two such connectors 176 and 177 project upwardly from the top of the housing 170 for receiving mating connectors 178 and 179 attached to respective ends of two pairs of conductors 180 and 181. When the connectors 178 and 179 are mated to the connectors 176 and 177, the conductors are connected to the power supply contained within the housing 170.

In an artificial tree having two or more vertical sections, the power supply housing 170 is preferably mounted on the uppermost collar 175 in the lowest of the three sections. Then one of the two connectors 176, 177 can supply power to the lowest section(s) of the tree, which generally is (are) the largest section(s), while the other connector supplies power to the smaller, upper sections of the tree. The electrical loads in the light strings in these two portions of the tree are typically about equal, and thus the output of the power supply can be split evenly between the two output connectors 176, 177.

As can be seen in FIG. 16, the outer end panel 182 of the housing 170 is most accessible to the user. This end panel 182 carries a manually operated on-off switch 183 for turning the power supply on and off, and an indicator light 184 that is illuminated whenever the power supply is connected to a power source. A dimmer knob 185 connected to the potentiometer P1 permits the user to control the light level by adjusting the position of the potentiometer. A bulb socket 186 permits the user to test a bulb by connecting the bulb to an appropriate power source within the housing. The panel 182 also contains a drawer 187 for storage of spare bulbs and fuses. Power for the circuitry within the housing 170 is supplied via cord 188.

To mount the housing 170 on the collar 175, a hook 189 extends upwardly from the housing. The weight of the housing 170 forces the lower end of the inside panel 190 against the pole 171, and a yoke 191 projecting from the inside panel keeps the housing centered on the pole.

The two pairs of conductors 180 and 181 are connected to respective connector blocks 192 and 193 each of which includes multiple connectors for receiving mating connectors crimped onto the ends of the wires of multiple light strings. For example, the connector block 193 typically receives the connectors on a multiplicity of light strings mounted on the bottom section(s) of a pre-lit tree. The other connector block 192 typically receives a multiplicity of light strings for the middle section of the tree. The top section(s) of the tree typically includes two or more light strings, which are connected to a smaller third connector block 196 connected to the block 192 via mating connectors 194 and 195 on the ends of two pairs of conductors leading to the respective blocks 192 and 196.

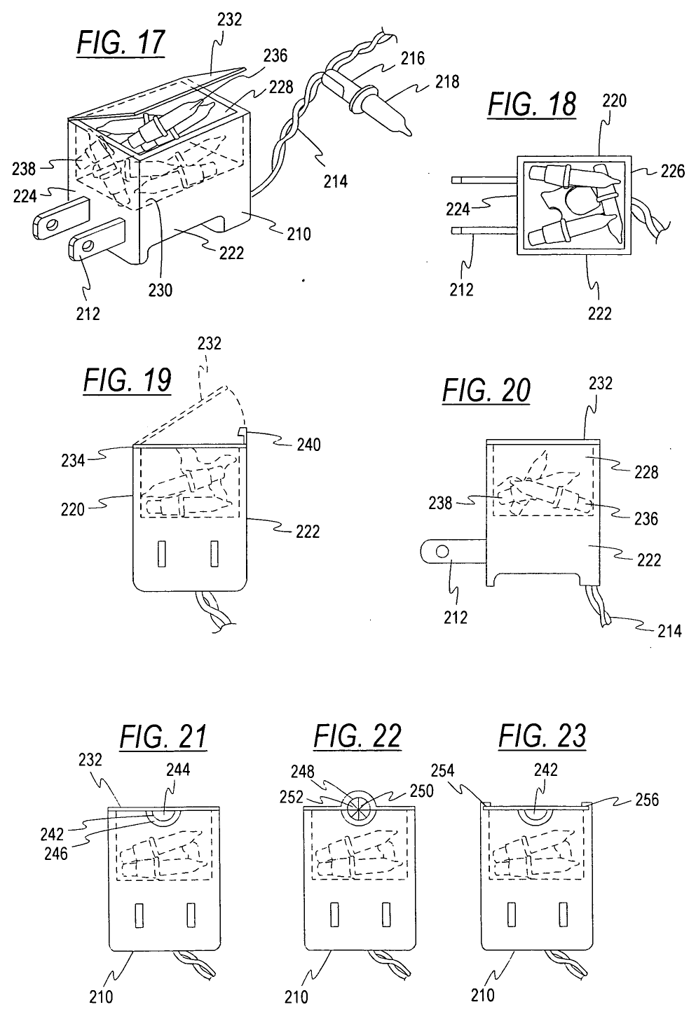

FIG. 17 illustrates an electrical plug 210 that may be attached to one end of the decorative light string to facilitate the storage of spare components. This plug 210 is molded of an electrically non-conductive material such as plastic or a rubber compound. There are electrical prongs 212 that engage a socket. Alternatively the electrical plug can be formed as a receptacle 211 (FIG. 25) on the female end or socket end of an electrical cord. There are two or more, commonly three, electrical wires 214 that connect to the prongs 212 or, in the case of a female plug, to the receptacles in the socket. Throughout this description, the term “electrical plug” shall also mean an “electrical socket”. The electrical wires 214 have a plurality of electrical sockets 216 connected to them. In the case of Christmas Lights, the electrical connection is generally a series connection. Each socket 216 has a lamp 218 mounted in it. There may be thirty-five to one hundred fifty lights in a string of Christmas lights.

As seen in FIGS. 17 and 18, the molded plug 210 has a pair of opposed sidewalls 220, 222, a front wall 224 and a rear wall 226. Alternatively the molded plug may be formed of other configurations such as a dome, cylinder or circle. Within the confines of the walls 220-226 is a compartment 228. The compartment 228 has a bottom 230. There is a cover 232 that closes the top of the compartment 228. The cover 232 is attached to the sidewall 220 by means of a molded or living hinge 234. The living hinge 234 can be formed at the same time that the electrical plug 210 is molded. This minimizes the cost and number of components necessary to attach the cover 232 to the sidewall 220. The cover 232 can be made of clear plastic or colored plastic or rubber, depending on the needs and desires of the manufacturer and user. The compartment is dimensioned to hold several spare lamps 236, spare fuses 238 and a bulb-pulling tool.

The cover 232 can also be provided with a set of raised domes or bubbles that are used to indicate light bulb voltage, amperage or other information relating to the bulbs or fuses. By depressing the appropriate domes or bubbles, the user has a visual indication of the bulbs or fuses to buy for replacement items. Additional information such as the number of lights in a string, the length of the string, the date purchased or other such indications can also be added to the cover by similar indicia. Alternatively, the voltage, amperage or other important information can be molded into the plug 210, the cover 232 or bottom 230 when the parts are formed. This is a safety feature so that the user always knows what size lamps and fuses he or she should be using with a string of lights.

In order to keep the cover 232 in a secure closed position on the compartment 228, there is provided a latch means 240 on the top of the side wall 222. The latch can be a molded piece of rubber that engages an edge of the cover 232 opposite the living hinge. Instead of a latch, a magnetic strip may be added to the top of the sidewall 222 and a complementary magnetic strip on the edge of the cover 232. Other closure devices could be utilized as known in the art. It is preferable that the cover be water-resistant to keep water from entering the compartment 228 and possibly damaging the spare lamps 236 or fuses 238.

As described above, there is provided a compartment 228 that is capable of storing spare lamps 236 and spare fuses 238 that is integral with the molded electrical plug 210. The spare components are readily accessible when needed. The user merely opens the cover 228, removes the needed spare, and closes the cover. There is no searching for the whereabouts of the spare parts bag or worrying about installing a wrong lamp or fuse. The current system of supplying the spare parts in a bag that is stapled to the wires between two of the bulbs also presents another safety issue. The staple can pierce the insulation and wire or can scratch the wire or the person removing the staple.

In FIG. 21, there is an alternative embodiment in which a semi-circular recess 242 is formed in the front wall 224. The semi-circular recess 242 forms an opening 244 that creates a lamp remover tool to remove burned out lamps from their respective sockets. The diameter of the opening 244 is substantially the same as the diameter of the base of the lamp 218. This allows the base of a burned out lamp 218 to be inserted into the opening 244 when the cover is opened. The cover is closed and held down by the user. This securely holds the lamp in the opening 244. The user then pulls the socket 216 away from the lamp 218. Optionally the recess 242 may have a metal insert 246 placed around its edge if the material forming the front wall 224 is not strong enough to withstand the force necessary to remove the burned out lamp. The recess is illustrated in the front wall 224 but can also be formed in the rear wall 226. A small piece of flexible material can also be formed on the cover or as part of the front wall 224 to partially or completely cover the opening 244. This keeps the spare lamps or fuses from falling out through the opening 244.

FIG. 22 illustrates another alternative embodiment. The cover 228 is formed with a semi-circular dome 248 that aligns with the semi-circular recess 242 in the front wall 224. The aligned dome 248 and recess 242 form a circular opening 250. The dimension should be slightly smaller than the diameter of the socket 216. When a burned out lamp 218 is inserted into the opening 250, the user holds the socket 216 in place. The lamp 218 is then pulled out from the socket 216. There is optionally provided a flexible webbed material 252 that has a plurality slits emanating from the center of the opening 250 toward the circumference of the opening 250. This provides a covered opening that is easily penetrated by a lamp 218 when it is inserted into the opening 250. The webbed material 252 can be easily formed with the cover 232 and front wall 224.

FIG. 23 illustrates another alternative embodiment in which the cover 232 is attached to the molded plug 210 by a different means. Instead of using a molded hinge 234, the cover 232 is held within a pair of U-shaped channels 254, 256 extending along the top of the sidewalls 220, 222. The U-shaped channels 254, 256 retain the edges of the cover 232 so that the cover can be removed from the compartment 228 by sliding the cover 232 horizontally along the top of the compartment 228. The same types of lamp removers as described in the alternative embodiments shown in FIGS. 21 and 22 can be used with the embodiment shown in FIG. 23.

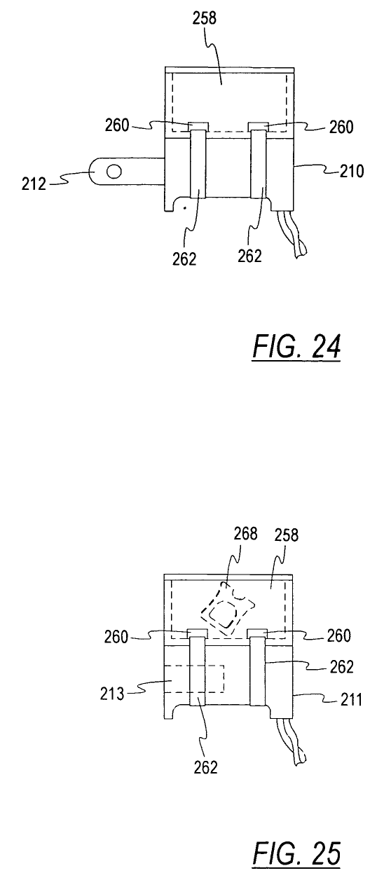

FIG. 24 illustrates another alternative embodiment in which a compartment 258 is formed as a separate stand-alone element. The compartment 258 can have the same features as the previously described compartment 228 such as different closure means and alternative lamp removal devices. However the compartment 258 has one or more open slots 260 at its bottom. The slots 260 receive plastic closure devices 262 such as conventionally used to secure bundles of wires together. These wire ties 62 securely hold the compartment 258 to the molded electrical plug 210. Other means such as clips or clamps can be used to attach the compartment 258 to the plug 210. Such alternative fastening means will be apparent to those skilled in the art. In this manner the compartments 258 can be added to existing Christmas Light strings.

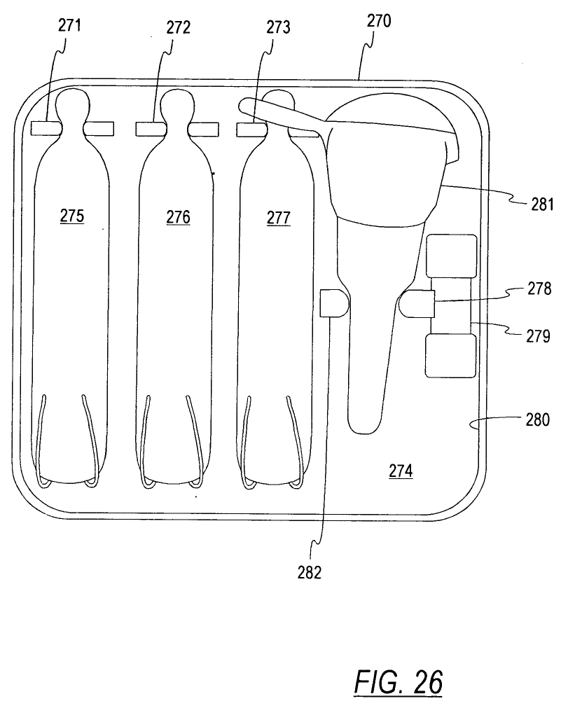

FIG. 25 illustrates another alternative embodiment in which the plug 210 is replaced by a receptacle 211 having electrically conductive socket receiving slots 213 to receive the electrical prongs 212. The compartment 258 is otherwise the same as described in FIG. 26 above. The compartment 258 is shown holding a bulb puller or bulb-removing tool 268. Any of the plugs 210 described herein can be replaced by a receptacle 11 with all other features of the compartment remaining intact.

FIG. 26 illustrates a modified storage compartment 270 that provides more organized storage of different types of replacement components. Three yokes 271, 272 and 273 extend upwardly from the bottom wall 274 of the compartment 270 to receive the tips of three replacement lamps 275, 276 and 277, respectively. The open upper end of each of the yokes 271-273 forms an opening that is slightly smaller than the minimum cross-sectional dimension of the lamp, and then flares out in the central portion of the yoke to approximately match the minimum cross-sectional dimension of the lamp. As a lamp is pressed down into the open end of the yoke, the two arms of the yoke are forced slightly apart to allow the lamp to enter, and then the arms spring back to capture the lamp within the yoke as the lamp enters the wider central portion of the opening in the yoke.

Near the right-hand side of the compartment as viewed in FIG. 26, a post 278 extends upwardly from the bottom wall 274 to capture a replacement fuse 279 against the adjacent sidewall 280 of the compartment 270. The side of the post 278 facing the sidewall 280 is undercut slightly beneath its free end to capture the fuse 279 after it has been pressed down into the space between the post 278 and the sidewall 280, deflecting the resilient post 278 slightly away from the sidewall 280 in the process.

The space between the post 278 and the end yoke 273 is utilized to store a lamp base 281 inserted between the post 278 and a second post 282 extending upward from the bottom wall 274. The second post 82 positions the lamp base 281 between the fuse 278 and the lamp 277.

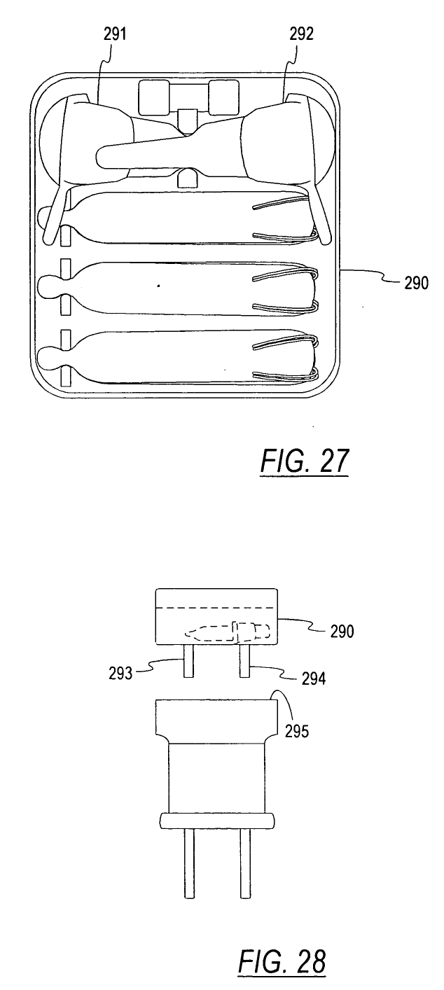

FIGS. 27-29 illustrate a modified storage compartment 290 that is dimensioned to receive two tiers of replacement components. The thickest components are the lamp bases 291 and 292, which are much smaller at their lower ends than at their upper ends. Thus, as can be seen in FIGS. 27 and 28, they are stored with their small ends overlapping, so that the depth of the storage compartment need be increased by only about 50% to receive the two overlapping bases 291 and 292. This increase in depth is sufficient to accommodate two tiers of lamps and fuses.

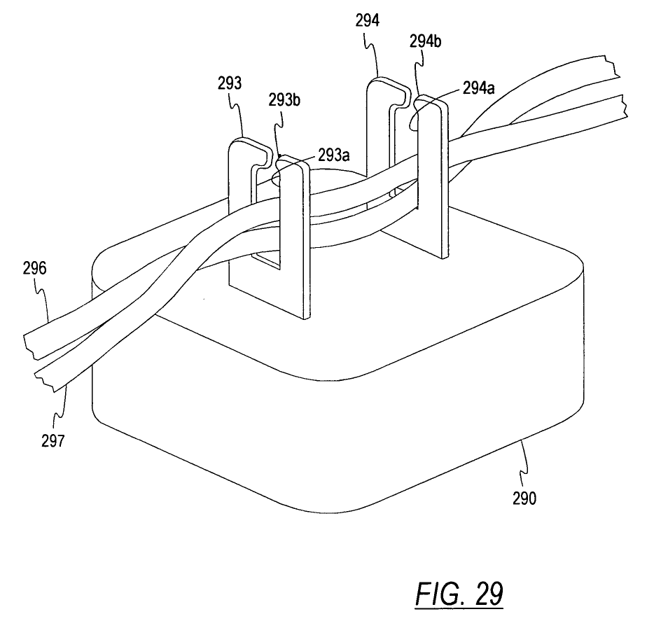

As can be seen in FIGS. 28 and 29, the storage compartment 290 is provided with two plastic prongs 293 and 294 formed as an integral part of the storage compartment and adapted to fit into the socket of a standard socket 295 on the end of a light string. Thus, the storage compartment 290 can be removably attached to a light string by simply plugging it into the socket typically provided on one end of a light string. In addition, as can be seen in FIG. 29, the plastic prongs 293 and 294 form notches 293a and 294a so that the prongs can be clipped to the wires 296 and 297 of a light string. Each of the notches 293a and 294a has a narrow throat 293b or 294b at its open end to hold the storage compartment 290 captive on the wires 296, 297 after the prongs 293, 294 have been pressed onto the wires.

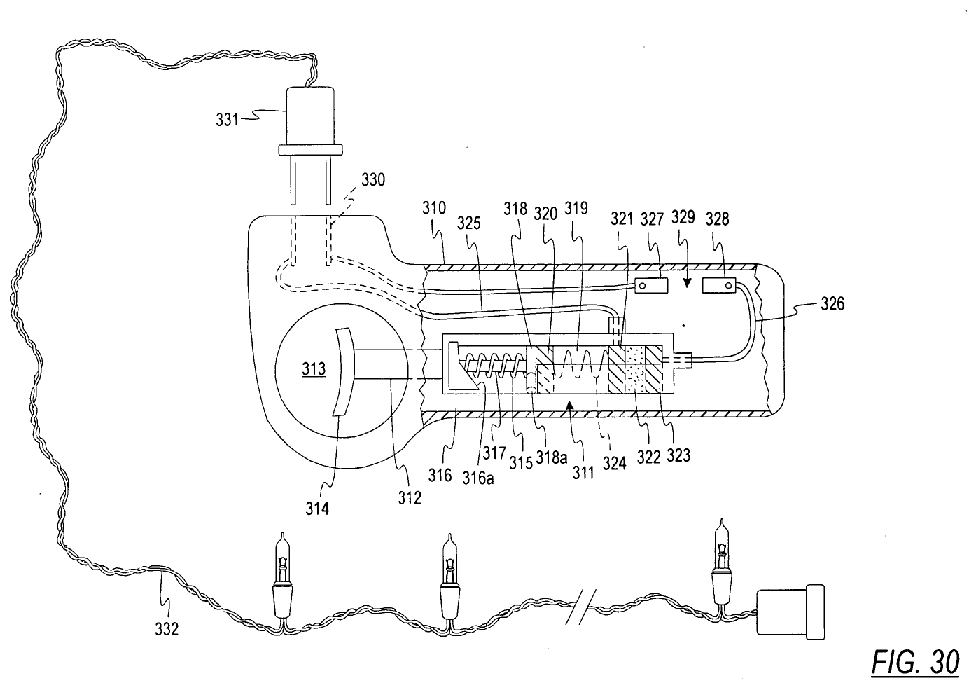

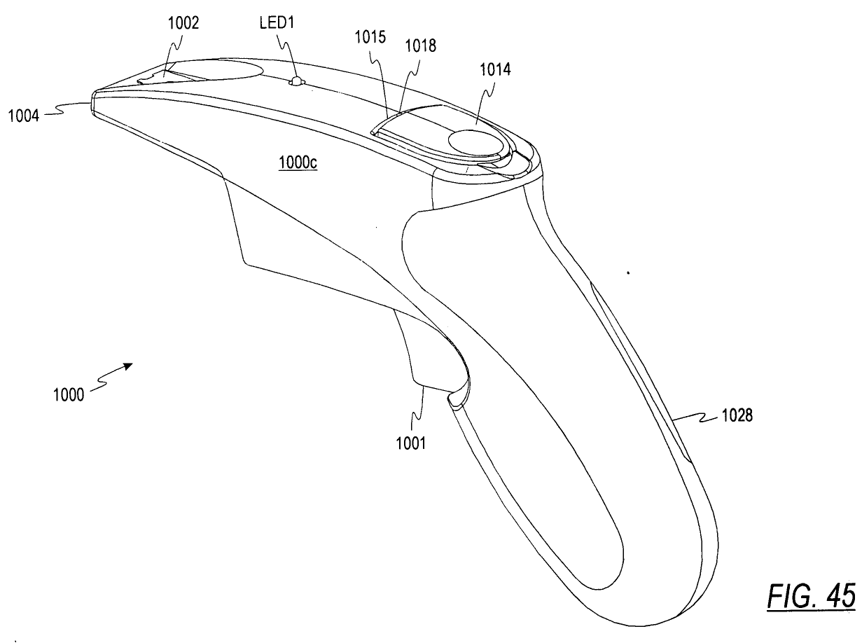

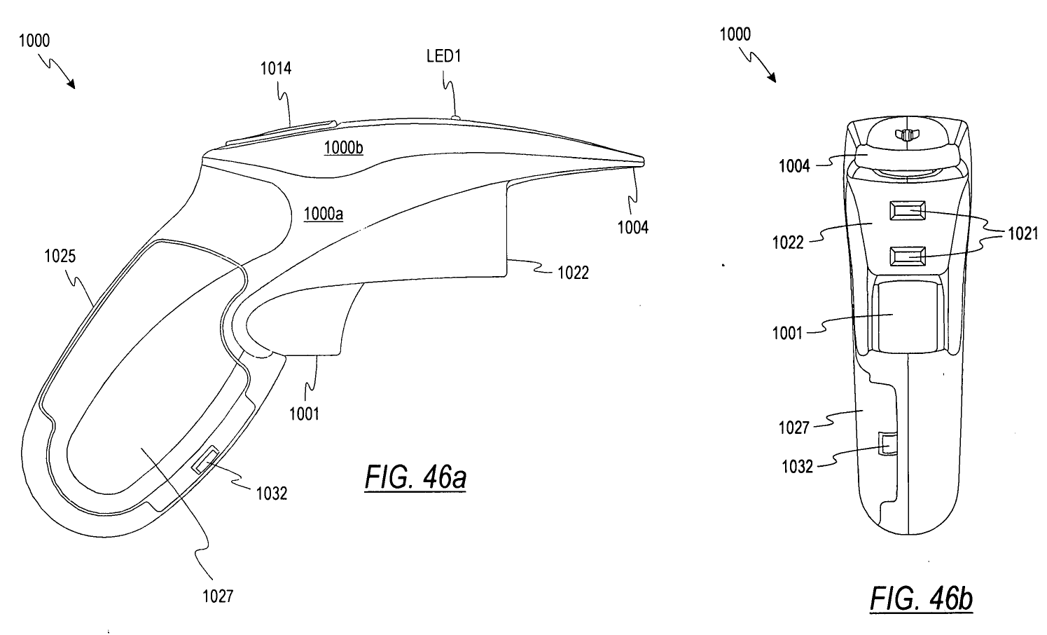

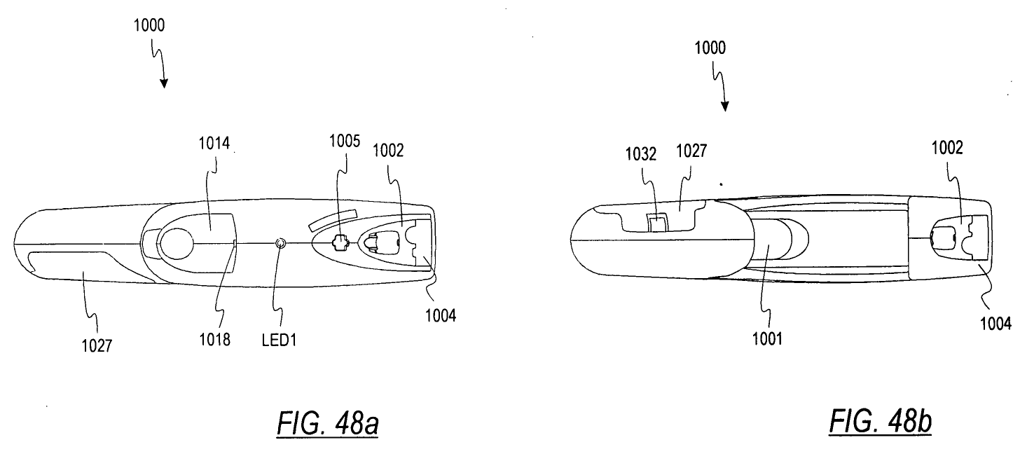

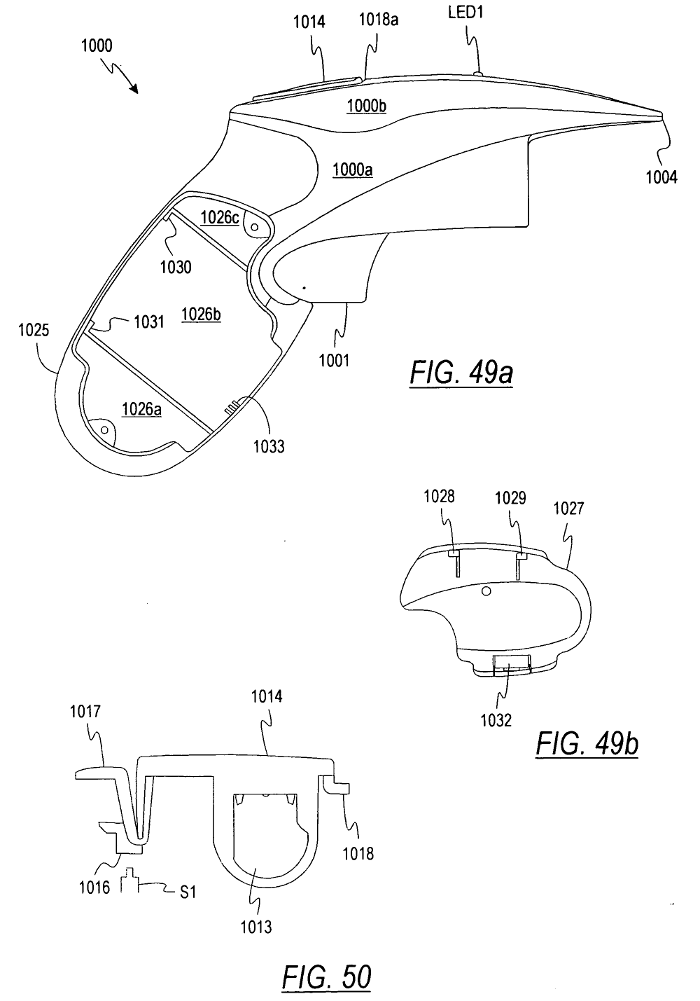

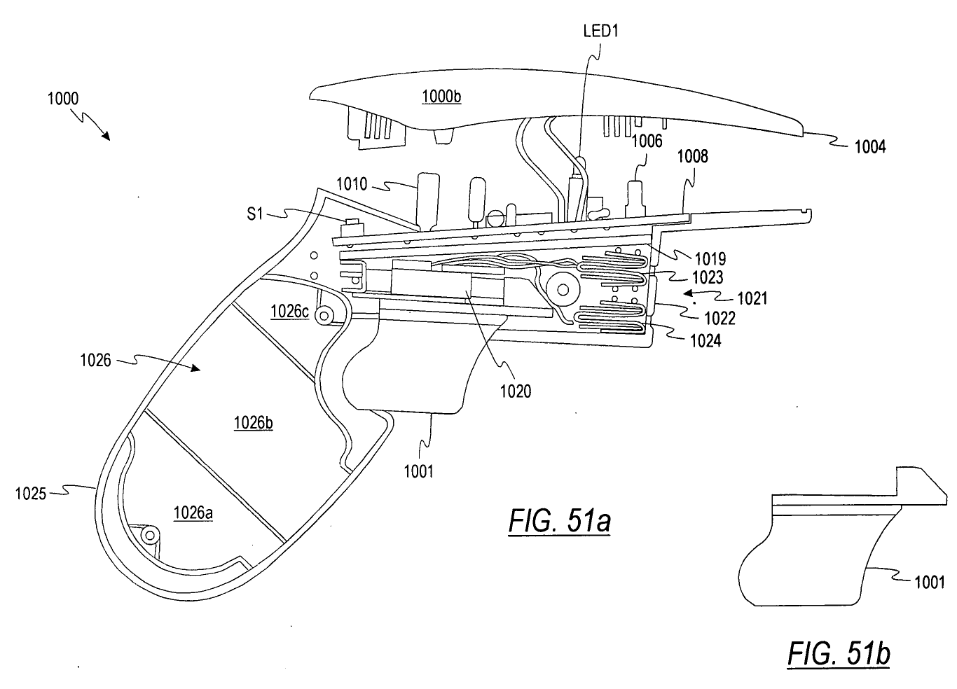

In the event of a failure of one or more bulbs in the decorative light string, the hand-held tool shown in FIGS. 30, 31-32 or 44-52 may be used to identify, and often repair, the failed bulb(s). In the illustrative embodiment shown in FIG. 30, a portable, hand-held housing 310 contains a conventional piezoelectric device 311 of the type used in lighters for gas grills, for example. The piezoelectric device 311 is actuated by a rod 312 that extends out of the housing 310 into a finger hole 313 where the rod 312 is attached to a trigger 314. When the trigger 314 is pulled, the rod 312 is retracted and retracts with it the left-hand end of a compression spring 315 and a cam element 316. The compression spring 315 is supported by a stationary rod 317 which telescopes inside the retracting rod 312 while the spring 315 is being compressed against a latch plate 318 at the right-hand end of the spring.

When the spring 315 is fully compressed, an angled camming surface 316a on the cam element 316 engages a pin 318a extending laterally from the latch plate 318, which is free to turn around the axis of the rod 317. The camming surface 316a turns the pin 318a until the pin reaches a longitudinal slot 319, at which point the compression spring 315 is released to rapidly advance a metal striker 320 against a striker cap 321 on one end of a piezoelectric crystal 322. The opposite end of the crystal 322 carries a second metal cap 323, and the force applied to the crystal 322 by the striker 320 produces a rapidly rising output voltage across the two metal caps 321 and 323. When the trigger 314 is released, a light return spring 324 returns the striker 320 and the latch plate 318 to their original positions, which in turn returns the cam element 316, the rod 312 and the trigger 314 to their original positions.

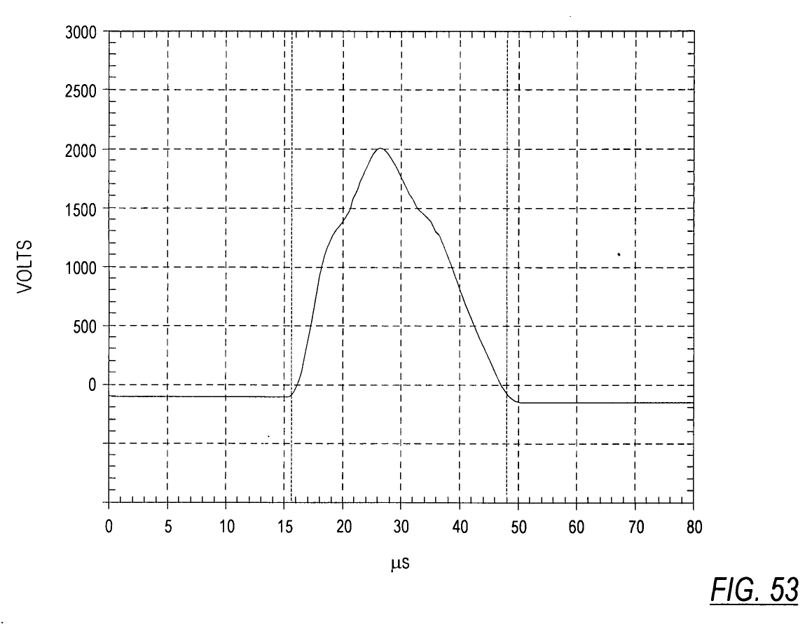

Although the piezoelectric device is illustrated in FIG. 30 as containing a single crystal 322, it is preferred to use those commercially available devices that contain two stacked crystals. The striking mechanism in such devices strikes both crystals in tandem, producing an output pulse that is the sum of the pulses produced by both crystals. FIG. 53 illustrates a pulse generated by such a pulse source connected to a 100-bulb light string with the first and last bulbs removed to show the pulse that would be applied to a defective shunt.

The metal caps 321, 323 are connected to a pair of conductors 325 and 326 leading to a socket 330 for receiving a plug 331 on the end of a light string 332. The conductor 326 may be interrupted by a pulse-triggering air gap 329 formed between a pair of electrodes 327 and 328, forming an air gap having a width from about 0.20 to about 0.25 inch. The voltage output from the piezoelectric crystal 322 builds up across the electrodes 327, 328 until the voltage causes an arc across the gap 329. The arcing produces a sharp voltage pulse at the socket 330 connected to the conductor 326, and in the light string 332 plugged into the socket 330. The trigger 314 is typically pulled several times (e.g., up to five times) to supply repetitive pulses to the light string.

Substantially the entire voltage of each pulse is applied to any inoperative shunt in a failed bulb in the light string, because the failed shunt in a failed bulb appears as an open circuit in the light string. The light string is then unplugged from the socket 330 and plugged into a standard AC electrical outlet to render conductive a malfunctioning shunt not repaired by the pulses. It has been found that the combination of the high-voltage pulses and the subsequent application of sustained lower-voltage power (e.g., 110 volts) repairs a high percentage of failed bulbs with malfunctioning shunts. When a malfunctioning shunt is fixed, electrical current then flows through the failed bulb containing that shunt, causing all the bulbs in the light string except the failed bulb to become illuminated. The failed bulb can then be easily identified and replaced.

The piezoelectric device 311 may be used without the spark gap 329, in which event the malfunctioning shunt itself acts as a spark gap. As will be described in more detail below, the piezoelectric device may be replaced with a pulse-generating circuit and an electrical power source. Circuitry may also be added to stretch the pulses (from any type of source) before they are applied to the light string so as to increase the time interval during which the high voltage is applied to the malfunctioning shunt.

In cases where a hundred-light set comprises two fifty-light sections connected in parallel with each other, each applied pulse is divided between these two sections and may not have enough potential to activate a malfunctioning shunt in either section. In these cases, an additional and rather simple step is added. First, any bulb from the working section of lights is removed from its base. This extinguishes the lights in the working section and isolates this working section from the one with the bad bulb. Next, the string of series-connected bulbs is plugged into the socket of the repair device, and the trigger-pulling procedure is repeated. The lights are then unplugged from the repair device, the removed bulb is re-installed, and the light set is re-plugged into its usual power source. Since the shunt in the bad bulb is now operative, all the lights except the burned out one(s) will become illuminated.

When a bulb does not illuminate because of a bad connection in the base of the bulb, the pulse from the piezoelectric element will not fix/clear this type of problem. Bad connections in the base and other miscellaneous problems usually account for less than 20% of the overall failures of light strings.

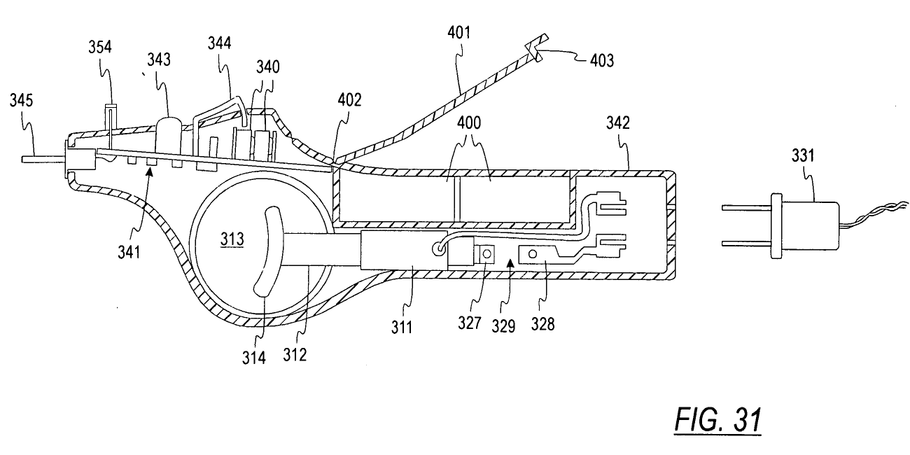

To offer the broadest range of capabilities, a modified embodiment of the present invention, illustrated in FIGS. 31-33h, incorporates both an open-circuit detection system and a bulb tester, thus providing the user a complete light care system. The detection system in the illustrative device of FIGS. 31-33h locates burned-out bulbs in a string that is plugged into a power source. A pair of batteries 340 power a circuit 341 built into a housing 342 and connected to a probe for sensing an AC electrostatic field emanating from the light string. When the probe is moved along the light string, it alters the operation of the circuit 341, which in turn energizes a visual and/or audible signaling device such as a light-emitting diode (“LED”) 41 projecting through an aperture in the top wall of the housing 342. Another suitable signaling device is a buzzer that can be energized by the circuit 341 to produce a beeping sound, as will be described in more detail below.

The circuit 341 is activated by a spring-loaded switch 344 that connects the circuit 341 with the batteries 340 when depressed by the user. The batteries 340 remain connected with the circuit 341 only as long as the switch 344 remains depressed, and are disconnected by the opening of the spring-loaded switch 344 as soon as the switch is released.

The circuit 341 includes a conventional oscillator and supplies a continual series of pulses to the LED 41 as long as (1) the circuit remains connected to the batteries, and (2) the probe detects an AC electrostatic field. As the detector is moved along the light string toward the burned-out bulb, the pulses supplied to the LED 41 cause it to flash at regular intervals. The same pulses may cause a buzzer to beep at regular intervals. There is no need for the user to repeatedly press and release the switch to produce multiple pulses as the detector traverses the light string. As the detector passes the burned-out bulb, the open circuit created by that bulb greatly reduces the electrostatic field strength, and thus the LED 41 is extinguished, indicating that the probe is located near the bad bulb.

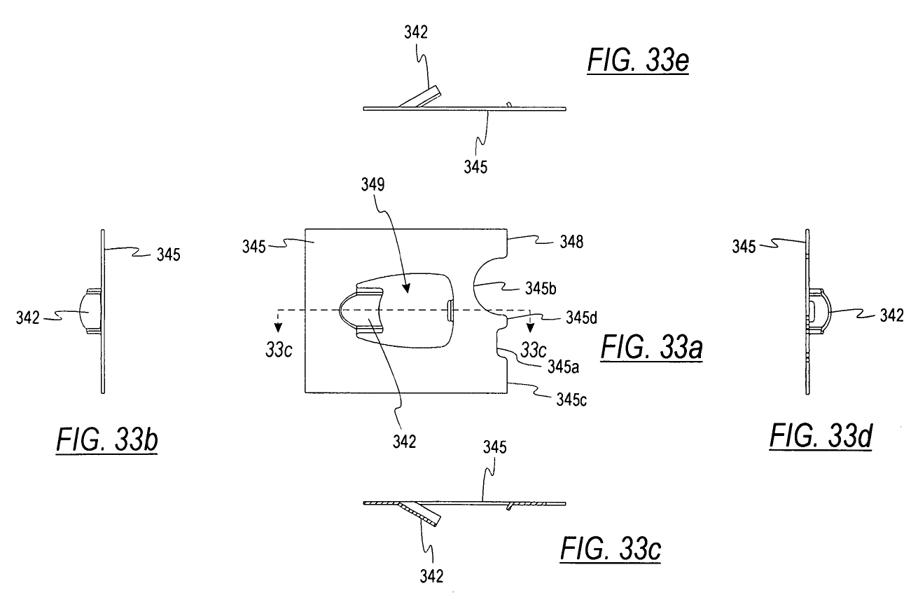

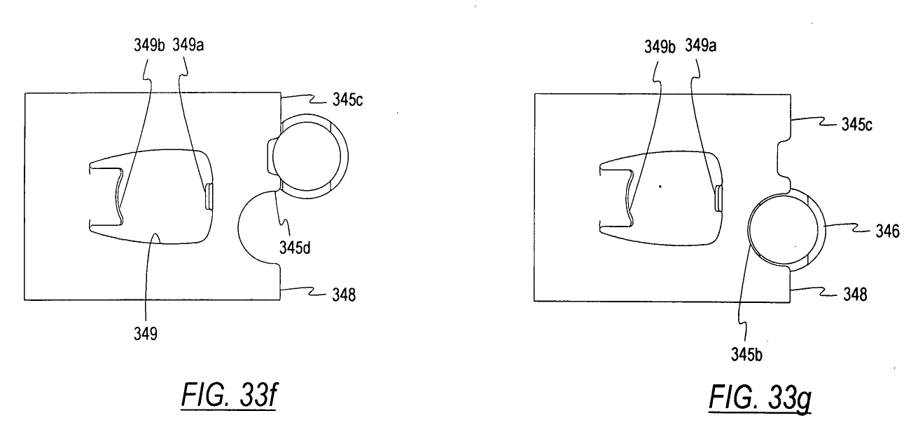

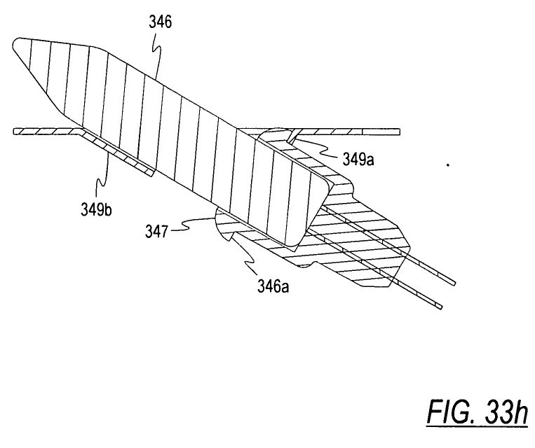

As can be seen in FIGS. 33a-33h, a tool 345 for facilitating removal of a burned-out bulb is mounted on the distal end of the housing 342. In the illustrative embodiment, the tool 345 is in the form of a flat blade having a front edge that forms a pair of arcuate recesses 345a and 345b that mate with the interface between a bulb 346 and its socket 347. The smaller recess 345a is flanked by a pair of tapered surfaces 345c and 345d that can be pressed into the bulb/socket interface to penetrate into that interface, as illustrated in FIG. 33f, and then twisted to pry the bulb out of its socket. After the interface has been opened slightly, the larger recess 345b can be pushed into the interface to open it more widely, as illustrated in FIG. 33g, and then twisted or tilted to remove the bulb from its socket. A tapered tab 348 at one end of the recess 345b can be inserted into the interface and twisted to pry the two parts away from each other. The central portion of the tool 345 forms an opening 349 shaped to permit the bulb 346 to extend through the blade, as illustrated in FIG. 33h, with the wide end of the opening 349 fitting over a flange 346a on the bulb base. A small tab 349a on the wide end of the opening 349 fits under a flange on the bulb base so that when the blade is pulled longitudinally away from the socket 347, the bulb and its base can be pulled out of the socket. The narrow end of the opening 349 is curved out of the plane of the blade to form a cradle 349b shaped to conform to the shape of the adjacent portion of the bulb, to avoid a sharp edge that might break the bulb while it is being extracted from its socket.

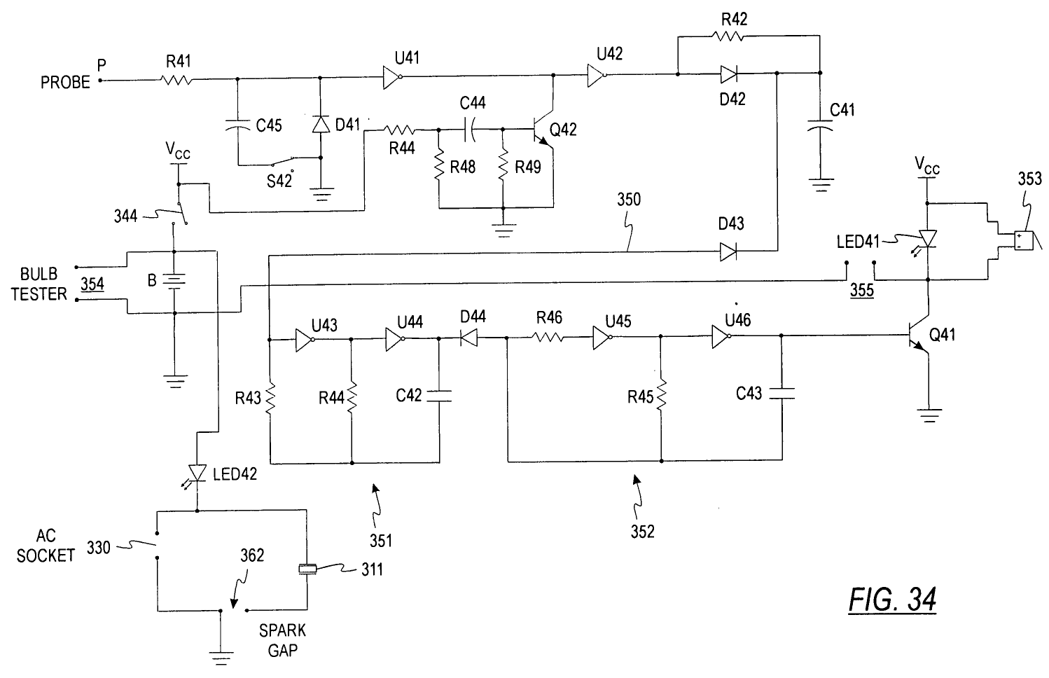

In a preferred electrostatic field detection circuit illustrated in FIG. 34, the manually operated switch 344 applies power to the circuit when moved to the closed position where it connects a battery B to Vcc. The battery B applies a voltage V_{cc} to the LED 41 which is then illuminated whenever it is connected to ground by a switching transistor Q41. The battery voltage V_{cc} also charges a capacitor C44 through a resistor R44. As the capacitor C44 charges, it turns on a transistor Q42, which pulls low the signal line between a pair of inverters U41 and U42 described below. The transistor Q42 turns off when the capacitor C44 is charged. The momentary low produced during the time the transistor Q42 is on triggers a pair of oscillators also described below, causing the LED 41 to flash to indicate that the circuit is energized, the battery is good, and the circuit is functional.

The probe P of the detector is connected to a resistor R41 providing a high impedance, which in turn is connected to an HCMOS high-gain inverter U41 and a positive voltage clamp formed by a diode D41. When the probe P is adjacent a conductor connected to an AC power source, the AC electrostatic field surrounding the conductor induces an AC signal in the probe. This signal is typically a sinusoidal 60-Hz signal, which is converted into an amplified square wave by the high-gain inverter U41. This square wave is passed through a second inverter U42, which charges a capacitor C41 through a diode D42 and discharges the capacitor through a resistor R42. The successive charging and discharging of the capacitor C41 produces a sawtooth signal in a line 350 leading to a pair of oscillators 351 and 352 via diode D43.

The signal that passes through the diode D43 triggers the oscillators 351 and 352. The first oscillator 351 is a low-frequency square-wave oscillator that operates at ˜10 Hz and is formed by inverters U43 and U44, resistors R43 and R44 and a capacitor C42. The second oscillator 352 is a high-frequency square-wave oscillator that operates at ˜2.8 kHz and is formed by inverters U45 and U46, resistors R45 and R46, and a capacitor C43. Both oscillators are conventional free-running oscillators, and the output of the low-frequency oscillator 351 controls the on-time of the high-frequency oscillator 352. The modulated output of the high-frequency oscillator 352 drives the transistor Q41, turning the transistor on and off at the 25-Hz rate to produce visible blinking of the LED 41. The high-frequency (2.8 kHz) component of the oscillator output also drives a buzzer 353 connected in parallel with the LED 41, so that the buzzer produces a beeping sound that can be heard by the user.

To locate a failed bulb, the switch 344 is held in the closed position while the probe is moved along the length of the light string, keeping the probe within one inch or less from the light string (the sensitivity increases as the probe is moved closer to the light string). The LED 41 flashes repetitively and the buzzer 353 beeps until the probe moves past the failed bulb, and then the LED 41 and the buzzer 353 are de-energized as the probe passes the failed bulb, thereby indicating to the user that this is the location of the bulb to be replaced. Alternatively, the LED 41 and the buzzer 353 will remain de-energized until the probe reaches the failed bulb and then become energized as the probe passes the failed bulb or other discontinuity in the light string, again indicating the location of the defect.

This detection system is not sensitive to the polarization of the energization of the light string while it is being scanned. Regardless of the polarization, both the LED 41 and the buzzer 353 change, either from activated to deactivated or from deactivated to activated, as the probe P moves past a failed bulb. Specifically, when the probe P approaches the failed bulb along the “hot” wire leading to that bulb, the LED 41 flashes and the buzzer 353 beeps until the probe P reaches the bad bulb, at which time the LED 41 is extinguished and the buzzer 353 is silenced. When the probe P approaches the failed bulb along the neutral wire, the LED 41 remains extinguished and the buzzer 353 remains silent until the probe P is adjacent the bad bulb, at which time the LED 41 begins to flash and the buzzer 353 begins to beep. Thus, in either case there is a clear change in the status of both the LED 41 and the buzzer 353 to indicate to the user the location of the bad bulb.

Another advantage of this detection system is that the automatic continuous pulsing of the LED 41 and the buzzer 353 provides both visual and audible feedback signals to the user that enable the user to judge the optimum distance between the detector and the light string being scanned. The user can move the detector toward and away from the light string while observing the LED 41 and listening to the buzzer to determine the distance at which the visual and audible signals repeat consistently at regular intervals.

To permit the sensitivity of the detector circuit to be reduced, a switch S42 permits a capacitor C45 to be connected to ground from a point between the resistor R41 and the inverter U41. This sensitivity adjustment is desirable because in the presence of a strong electrostatic field from a nearby light string, the LED 41 may continue to flash and give false readings.

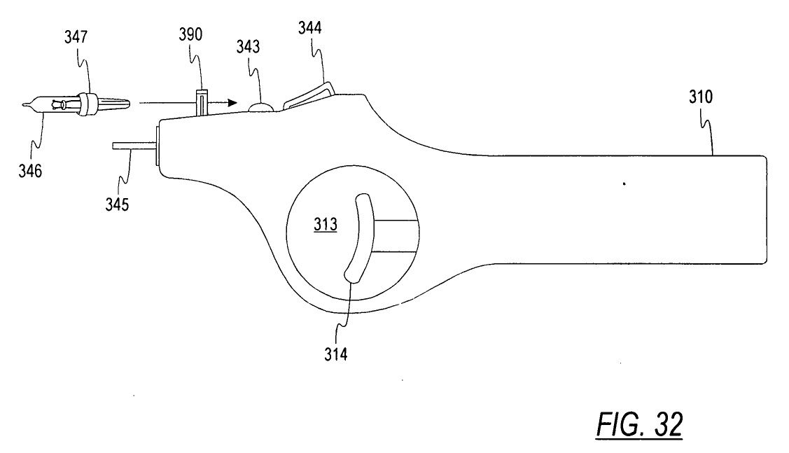

To permit the testing of bulbs with the same device that is used to detect burned-out bulbs, a bulb-testing loop 354 (FIGS. 31 and 32) is formed as an integral part of the housing 310. The inside surface of the loop 354 contains a pair of electrical contacts connected to the same battery B (FIG. 34) that powers the detection circuit, to supply power to the bulb being tested. These contacts are positioned to contact the exposed folded ends of the filament leads on opposite sides of the bulb base when the bulb base is inserted into the loop. The loop 354 may be designed to accommodate the latest commercial miniature bulbs that include a long tab on the bottom of the bulb base to maintain creepage/clearance distances and push snow and dirt out of the socket when it is installed as specified in UL 588, Christmas-Tree and Decorative-Lighting Outfits, Sixteenth Edition. As seen in FIGS. 31 and 32, the loop 354 is preferably placed on the top of the housing 310, although the location is not determinative of its function.

In operation, a bulb base is inserted into the loop 354 from the lower end of the bulb base, and the tapered neck of the base extends all the way through the loop 354. The thickened section of the base limits the insertion of the bulb. At this point, the filament leads exposed on the base of the bulb engage the electrical contacts on the inside surface of the loop 354. Since the contacts have a battery voltage across them, the bulb will illuminate if it is good. If the bulb fails to illuminate, the user can conclude that the bulb is no longer functional.

For the convenience of the user, the housing 310 further includes an integrated storage compartment 400 (see FIG. 31) for storage of spare parts such as bulbs and/or fuses. This storage compartment 400 can be molded into the housing 310. The cover 401 of the storage compartment 310 may be made with an integrally molded living hinge 402 and an integral latch 403. An example of an alternate construction would be a sliding cover, instead of a hinged cover, over the compartment holding the spare parts. The storage compartment is preferably divided into multiple cavities, as can be seen in FIG. 31, to permit different components to be separated from each other to facilitate retrieval of desired components.

A fuse-testing socket 355 may also be provided to permit the testing of fuses as well as bulbs. In the illustrative circuit of FIG. 34, the fuse-testing socket is connected in series with the LED 41 and the battery B, so that insertion of a good fuse into the socket 355 illuminates the LED 41 as a good-fuse indicator, while a defective fuse does not illuminate the LED 41.

The detection circuit of FIG. 34 also includes a continuity indicator to provide the user with a visible indication when a bulb shunt has been fixed by pulses from the piezoelectric device 311. Thus, a second light-emitting diode LED 42 (typically a green LED) is connected from the positive side of the battery B to one side of the socket 330 to which the light string is connected. The piezoelectric device 311 and its spark gap 362 are connected across the socket 330 that receives the plug of the light string. It can be seen that the switch 344 isolates the piezoelectric circuit from the detection circuit so that the detection circuit is protected from the high-voltage pulses that are generated to repair a malfunctioning shunt. When a malfunctioning shunt in the light string is repaired, current flows from the battery B through LED 42 and the light string to ground, thereby illuminating LED 42 to indicate to the user that the shunt has been fixed and continuity restored in the light string.

When LED 42 illuminates, indicating that the shunt has been fixed, the light string is then unplugged from the socket 330 and plugged into a standard AC outlet. All the bulbs in the light string will now illuminate, with the exception of the failed bulb, which can be quickly detected and replaced. If desired, the removed bulb can be tested in the loop 354 before it is replaced, to confirm that the failed bulb has been properly identified.

When the LED 42 does not illuminate after the trigger 314 has been pulled several times, the user still unplugs the light string from the socket 330 and plugs it into an AC outlet. As described above, this additional, sustained AC power may render operative a shunt not rendered operative by the high-voltage pulses. In either event, the detector may be used to locate the failed bulb if the shunt does not become operative.

The high-voltage pulses used to fix a malfunctioning shunt in a failed bulb may be generated by means other than the piezoelectric source described above. For example, the DC output of a battery may be converted to an AC signal that is passed through a step-up transformer to increase the voltage level, rectified and then used to charge a capacitor that discharges across a spark gap when it has accumulated a charge of the requisite magnitude. The charging and discharging of the capacitor continues as long as the AC signal continues to be supplied to the transformer. The resulting voltage pulses are applied to a light string containing a failed bulb with a malfunctioning shunt, as described above.

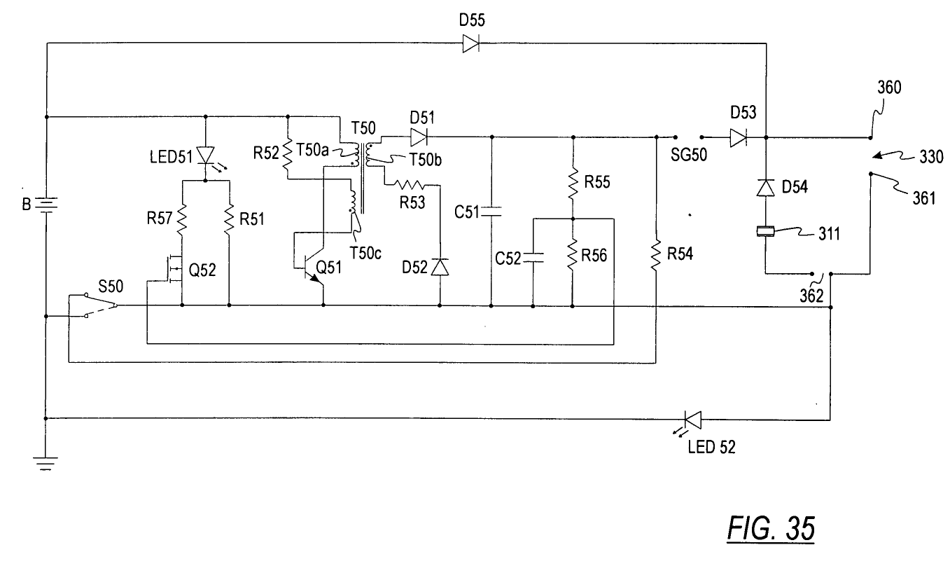

FIG. 35 illustrates a battery-powered circuit for generating high-voltage pulses that may be used independently of, or in combination with, the piezoelectric device 311. The illustrative circuit includes the piezoelectric pulse generator 311 described above, for producing high-voltage pulses across a failed bulb in a light string connected across terminals 360 and 361 in the socket 330. A diode D54 isolates the piezoelectric device 311 from the rest of the circuit, which forms a second high-voltage pulse source powered by a battery B. The spark gap 362 that develops the threshold voltage for the pulse from the piezoelectric device 311 is located between the terminal 361 and the device 311.

Before describing the pulse-generating circuit in FIG. 35, the overall sequence of operations for troubleshooting an extinguished light string will be described. The battery-powered pulse is produced by simply pressing a switch and holding it down until an LED51 glows brightly, indicating that a capacitor has been fully charged. A pulse from the piezoelectric device 311 is produced by pulling the trigger 314 (as shown in FIG. 32) several times. If either type of pulse fixes a malfunctioning shunt in a failed bulb, an LED52 is illuminated. If either type of pulse by itself does not fix a malfunctioning shunt, the two pulses can be generated concurrently, which will fix certain shunts that cannot be fixed by either pulse alone.

In general, there are four types of bulbs encountered in actual practice. First, there are bulbs in which the shunt will be fixed by either type of pulse by itself, and thus either the battery-powered pulse or the piezoelectric pulse may be used for this purpose. Second, there are bulbs in which the shunt can be fixed only with the higher-energy pulse produced by concurrent generation of both the battery-powered pulse and the piezoelectric pulse. Third, there are bulbs in which the shunt cannot be fixed, but the failed bulb will glow when the battery-powered circuit constantly applies a high voltage to the bulb; the switch is held down until the glowing bulb is visually detected. Fourth, there are bulbs that will not glow, but will blink or flash in response to the higher-energy pulse produced by concurrent generation of both the battery-powered pulse and the piezoelectric pulse; this pulse can be repeated until the defective bulb is detected by visually observing its flash.

Returning now to FIG. 35, when the pulse from the piezoelectric device 311 fixes the malfunctioning shunt, a green light-emitting diode LED52 is illuminated by current flowing from the battery B through a diode D55, the light string connected to terminals 360 and 361, and the LED52 to ground. The diode D55 protects the remaining circuitry from the high-voltage pulses produced by the piezoelectric device 311. If the shunt is still not conductive after being pulsed by the piezoelectric device 311, current does not flow through the light string and thus the LED52 remains extinguished. Thus, LED52 acts as a continuity indicator to provide the user with a visible indication of whether the malfunctioning shunt in the light string has been fixed.

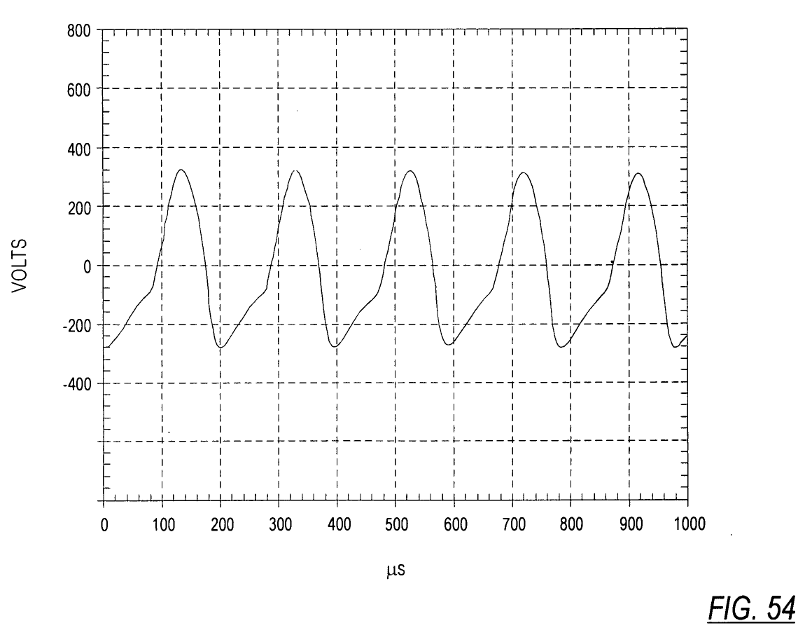

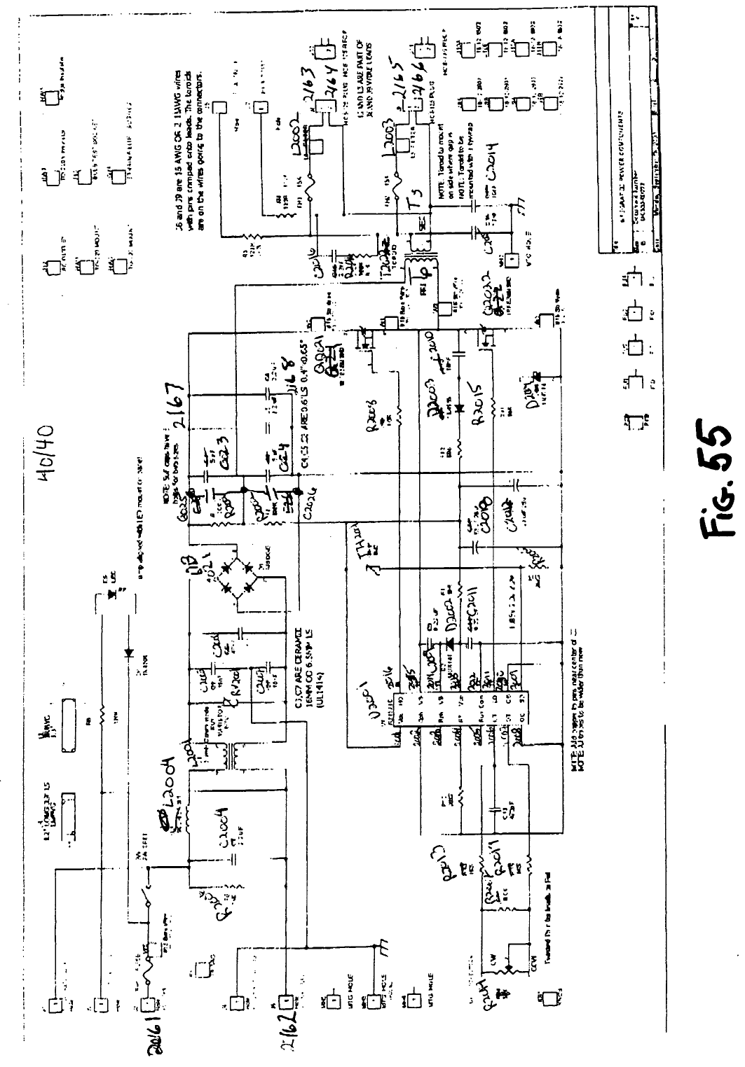

The balance of the circuit shown in FIG. 35 generates the battery-powered, high-voltage pulse. A switch S50 is pressed to connect the battery (or batteries) B to a conventional ringing choke converter or blocking oscillator operating at a relatively low frequency, e.g., 6.5 kHz, under nominal load. The oscillator converts the 3-volt DC output of the battery B to an AC signal that is supplied to the primary winding T50a of a step-up transformer T50. The stepped-up voltage from the secondary winding T50b, which may be hundreds or even thousands of volts AC, is rectified by a pair of diodes D51 and D52 and then stored in a capacitor C51, charging the capacitor C51 to greater than 500 volts. The stored energy is: ½CV2 where C=0.33 uF 500V−0.04125 joules. FIG. 54 illustrates a series of pulses produced by the oscillator alone connected to a 100-bulb light string with the first and last bulbs removed.

As it may take several seconds for the capacitor C51 to fully charge, the light-emitting diode LED51 indicates when the proper charge has been established. As the voltage on C51 reaches its maximum value, a voltage divider formed by a pair of resistors R55 and R56 starts to bias “on” an N-channel MOSFET Q52. (The resistors R55 and R56 also provide a leakage path for the capacitor C51.) The LED51 increases in brightness when the Vg-s threshold of Q52 is reached and becomes brighter as the Vg-s increases. A capacitor C52 is charged through the resistor R55 and provides a time delay to insure a full charge on the capacitor C51. Q52 and a resistor R57 are in parallel with the resistor R51 and thus lower the total resistance when Q52 conducts, thereby increasing the current through LED51 to make it glow brighter. The resistor R57 serves as a current-limiting resistor while Q52 is conducting. When the output of the red LED51 reaches constant brightness, the output voltage is at its maximum.

When the charge on the capacitor C51 builds up to a threshold level, e.g., 500 volts, it reaches the firing voltage of a gas-filled, ceramic spark gap SG50, thereby applying the voltage to the failed bulb in the light string and reducing the intensity of LED51. This voltage continues to build until it produces at least a partial breakdown of the dielectric material in the malfunctioning shunt. If the LED52 is not illuminated, the switch S50 is held in the depressed position, which causes the charging and discharging cycle to repeat. This is continued for as long as S10 is depressed, and if the LED52 is still not illuminated, the user pulls the trigger 314 the next time the LED51 reaches maximum brightness. This produces the concurrent pulses from both the piezoelectric device 311 and the battery-powered circuit. When the device is turned off, any remaining charge on the capacitor C51 is discharged through a resistor R54.

The high-voltage pulse from the piezoelectric device produces an arc across the spark gap 362, thereby creating a discharge path for the energy stored in the capacitor C51. If the resulting pulse from the piezoelectric device 311 (or combined pulse from both the piezoelectric device 311 and an MOV) fixes the malfunctioning shunt, the LED52 is illuminated. If the LED52 is not illuminated, the trigger 314 may be pulled several more times to produce successive combined pulses. If the green LED51 is still not illuminated, the user may proceed to the detection modes to attempt to identify the failed bulb or other defect, so that the bulb can be replaced or the other defect repaired.

A first detection mode causes a failed bulb to glow by supplying the light string with the pulse from only the battery-powered circuit, independently of the piezoelectric device 311, by again depressing the switch S50. Again the pulse-triggering device breaks down when the voltage builds up to a threshold level, and then a high voltage will be continually applied to the failed bulb or other discontinuity as long as the switch is held down. This causes a failed bulb of the third type described above to glow, so that it can be visually identified and replaced.

A second detection mode causes a failed bulb to flash by generating concurrent pulses from the piezoelectric device 311 and the battery-powered circuit. As described previously, this combined pulse is produced by pressing switch S10 until LED51 illuminates, and then pulling the trigger 314 (as shown in FIG. 32) to activate the device 311. This causes a failed bulb of the fourth type described above to flash, so that it can be visually identified and replaced.

The circuit of FIG. 35 permits the user to quickly locate and replace a failed bulb without attempting to fix the shunt associated with that bulb, or the user can first attempt to fix a malfunctioning shunt with high-voltage pulses from either or both of two different sources. If the user does not see a bulb glow or flash the first time a pulse is generated, the pulses may be repeated until a glow or flash is detected.

If desired, the output voltage of the battery-powered circuit can be increased by increasing the turns ratio between the secondary and primary windings of the step-up transformer T50. Also, the circuit parameters may be selected so that the gas-filled spark gap or other triggering device does not break down until the piezoelectric device 311 is also triggered.

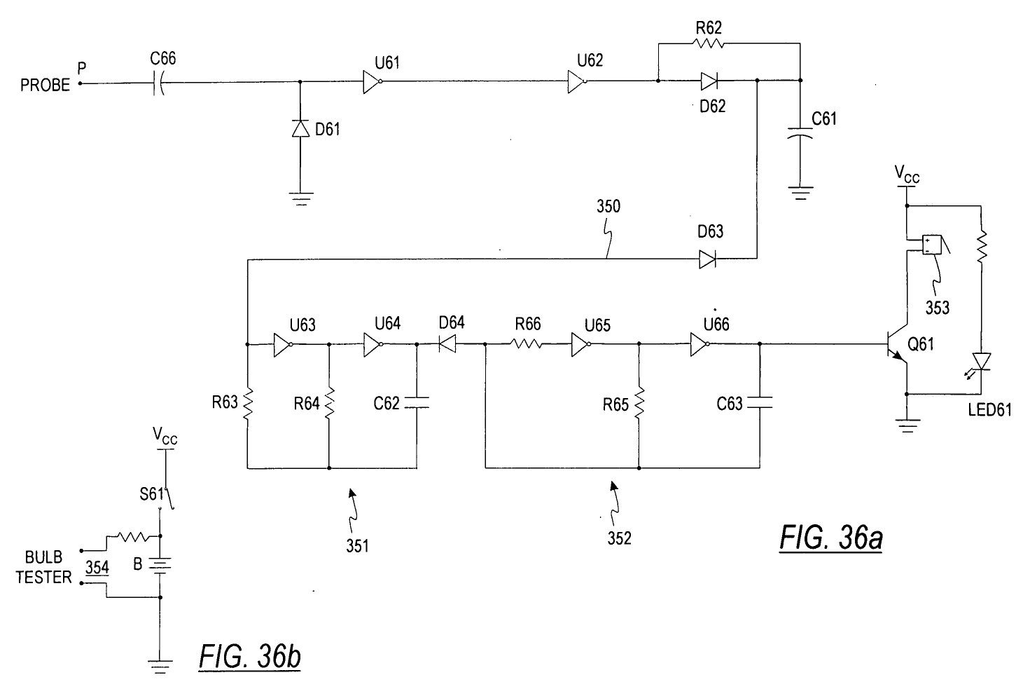

FIG. 36a is a schematic diagram of a circuit that can be used as an alternative to the circuit of FIG. 34 for identifying the location of a failed bulb in a light string. FIG. 36b shows the battery B that is used to provide the voltage V_{cc} that powers the buzzer 353 and LED61 in the circuit of FIG. 36a whenever the switch S61 is closed. The circuit in FIG. 36a is the same as the circuit in FIG. 34 except that (1) the circuit of FIG. 36a eliminates LED42, the sensitivity switch S42 and its associated capacitor C45, and the sub-circuit that includes the transistor Q42, and (2) the resistor R41 is replaced by an electrolytic capacitor C66(e.g., 4.7 μF). It has been found that the use of the electrolytic capacitor C66 provides more stable and reliable operation over a fixed range of distances between the probe and the wires of the light string. That is, the response of the buzzer 353 remains the same for different light strings, and different ambient conditions, as long as the probe is held within ⅛ to one inch from the wires of the light string.

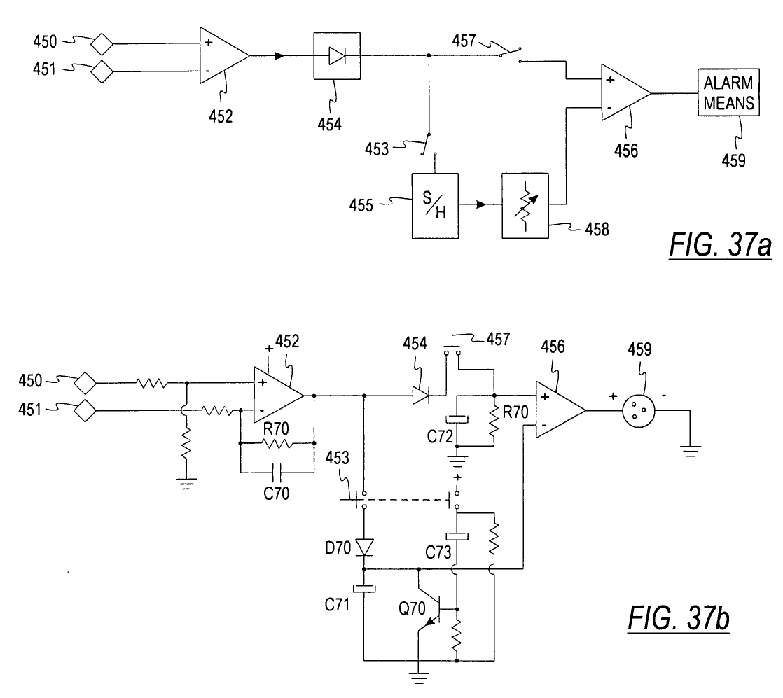

Another alternative to the circuit of FIG. 34 is the circuit shown in FIGS. 37a and 37b, which is a sample-and-hold differential detector. Referring first to the block diagram in FIG. 37a, the AC electrostatic field around an energized light string is detected by a capacitive sensor comprising a pair of spaced parallel plates 450 and 451 connected to the positive and negative inputs of a differential amplifier 452. The plates 450 and 451, which are typically about 0.5 inch square, are located on opposite sides of the light string and pick up the AC field as they are moved along the length of the light string. When the sensor is close to a failed bulb, the field strength decreases by about 50%, and thus the purpose of the detection circuit is to detect that drop in field strength.

Before scanning a light string, the sensor is positioned near the plug end of the wires, and a “sample” switch 453 is closed momentarily to store a sample of the field strength at that location, where the field strength should be at its maximum. More specifically, the output of the differential amplifier 452 is passed through a rectifier 454 and stored in a conventional sample-and-hold circuit 455 when the switch 453 is closed. This stored sample is then used as a reference signal input to a comparator 456 during the scanning of the light string. The other input to the comparator is the instantaneous rectified output of the amplifier 452, which is supplied to the comparator whenever a “test” switch 457 is closed. If desired, the stored sample may be scaled by a scaling circuit 458 before it is applied to the comparator 456. For example, the stored sample may be scaled by about ¾ so that the threshold value used in the comparator is about 75% of the maximum field strength, as determined by the sample taken near the plug end of the wires of the light string.

The comparator 456 is designed to change its output when the actual field strength falls below about 50% of the threshold value, indicating that the sensor is adjacent a bad bulb. An alarm or indicator 459 responds to the change in the output of the comparator 456 to produce a visible and/or audible signal to the user that a bad bulb has been located. The sample level can also be taken with the plug in the unpolarized position so that the change at the defective bulb corresponds to an increase in the level instead of a decrease. The threshold value can also be set so that this increase above the sample level triggers the alarm or indicator. The two approaches can also be combined so that the customer does not need to check the polarity of the plug before testing the string. The sample is taken and then circuitry looks for a change, either up or down, and either will trigger the indicator.

FIG. 37b is a schematic diagram of a circuit for implementing the system illustrated by the block diagram of FIG. 37a. The differential amplifier 452 includes a capacitor C70 in parallel with its feedback resistor R70 to roll off the high frequency response and thereby prevent erratic operation from noise and RF signals propagating along the power line. When the “sample” switch 453 is momentarily closed, the output of the differential amplifier is passed through a diode D70 to an electrolytic capacitor C71. The diode D70 functions as a half wave rectifier, while the capacitor C71 stores the peak level of the signal for use as a threshold signal in the comparator 456. Closure of the “sample” switch 453 also sends a pulse through a capacitor C73 to the base of a transistor Q70 to turn the transistor on for about 0.01 second to discharge the previously stored sample before the new sample is stored in the capacitor C71.

As the sensor plates 450, 451 are moved along the light string, the “test” switch is closed to supply the rectified output of the differential amplifier 452 to a current-value storage filter formed by an electrolytic capacitor C72 and a resistor R70 connected in parallel with each other between the switch 457 and ground. The value stored in the filter is supplied to the positive input of the comparator 456 which compares that value with the threshold value from the electrolytic capacitor C71. When the current value falls below a predetermined value, the comparator output changes to activate the alarm device 459.

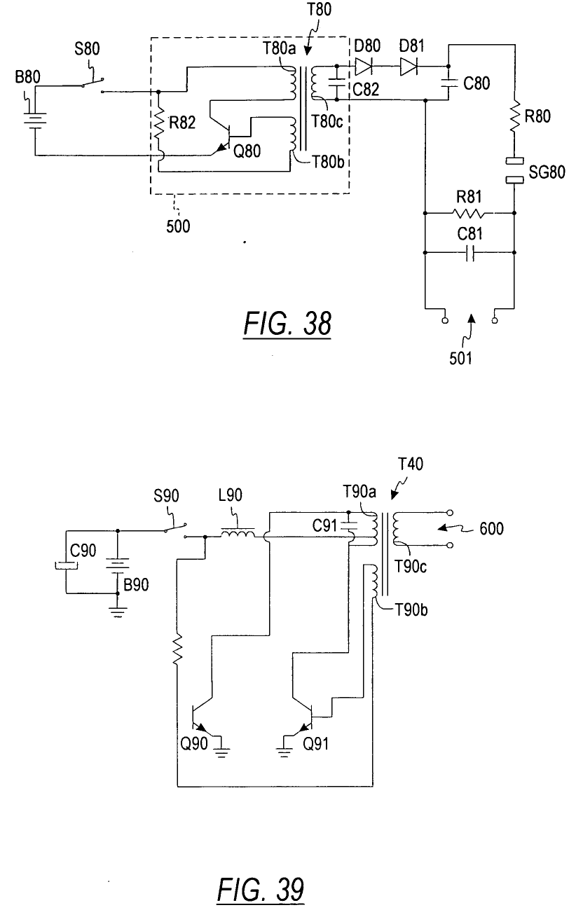

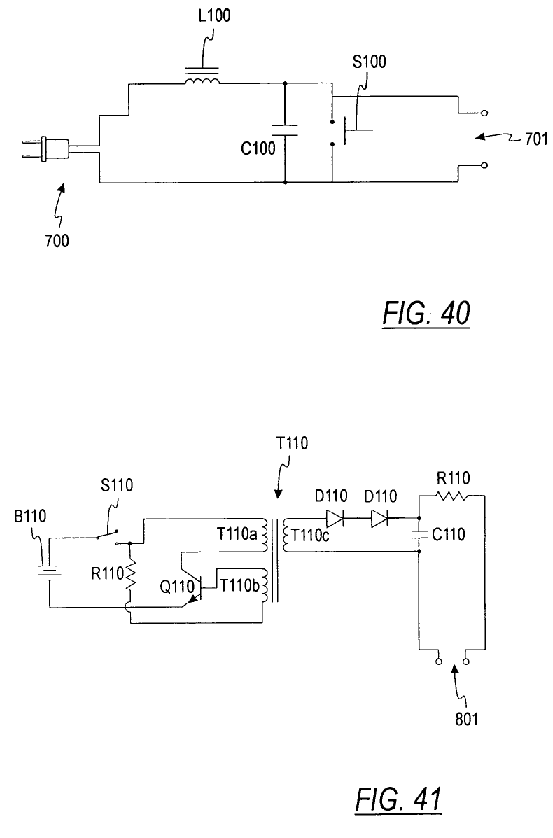

A variety of different circuits may be used to generate signals (which in some embodiments may be pulsed signals) of a magnitude greater than the standard AC line voltage to fix a malfunctioning shunt. One such alternative circuit is illustrated in FIG. 38, in which a battery B80 supplies DC power to a blocking oscillator 500 to generate a high-voltage AC signal that is rectified by a pair of diodes D80 and D81 and then used to charge a capacitor C80. When the capacitor C80 charges to a predetermined level, it discharges through a resistor R80 and a spark gap device SG80 (such as a gas discharge or neon tube) to produce the high-voltage pulses that are applied to a light string plugged into a socket 501. The resistor R80 functions to stretch the pulses, while the spark gap device SG30 controls the pulse shape and voltage level. It has been found that the addition of a resistance (e.g., ˜1000 ohms) in series with the discharge path of the capacitor into the light string increases the rate of success in fixing malfunctioning shunts.

Operation of the oscillator 500 is initiated by closing a switch S80 that supplies power from the battery B80 to the primary winding T80a and an auxiliary winding T80b of a transformer T80. A transistor Q80 has its collector and base connected to the two windings T80a and T80b, respectively, and its emitter is connected to the negative side of the battery B80. A resistor R82 is connected in series with T80b to supply base current to Q80 from T80a and T80b. The blocking oscillator operates in the conventional manner, producing a stepped-up AC signal in the secondary winding T80c of the transformer as long as the switch S80 remains closed. A filtering capacitor C82 is connected across the secondary winding T80c.

FIG. 39 illustrates a current-fed sinusoidal wave converter that may be used as an alternative to the circuit of FIG. 38. Power is supplied to the converter from a battery B90 via inductor L90 whenever a switch S90 is closed. The battery B90 is connected in parallel with an electrolytic capacitor C90 that stores energy from the battery for producing the desired high-voltage signal. The desired sinusoidal signal is produced by a conventional sinusoidal-wave generating circuit that includes a pair of transistors Q90 and Q91 connected to a pair of primary windings T90a and T90b of a transformer T90. A capacitor C91 is connected across the winding T90a. As long as the switch S90 remains closed, the transistors Q90 and Q91 are repetitively turned on and off, with one of the transistors always being on while the other is off, so as to produce a sinusoidal output signal in the secondary winding T90c of the transformer T90. This sinusoidal output is applied directly to a light string plugged into a socket 600 connected to opposite ends of the winding T90c.

FIG. 41 illustrates a circuit that uses a battery B110 as a power source and a conventional blocking oscillator consisting of the NPN transistor Q110; a transformer T110 with a primary winding T110a, a feedback winding T110b, and a secondary winding T110c; and a resistor R110. The transformer T110 is a step-up transformer with a secondary winding T110c consisting of many turns to raise the peak AC voltage to about 1000 volts, which is rectified by a pair of diodes D110 and D111 and used to charge a capacitor C110(e.g., 0.1 μF) to a voltage determined by the breakdown voltage of the defective shunt in the failed bulb. When this voltage is reached, typically 500 to 1000 V, the oxide or other insulation on the shunt breaks down and the voltage across the bulb falls abruptly to a low value as a heat-producing discharge occurs between the shunt and the filament support wires. This discharge has been shown to cause breakdown and burn-through of the oxide in a malfunctioning shunt in a light string plugged into a socket 801, rendering the shunt conductive and allowing the light string to function normally. Shaping the pulse by the use of inductive, capacitive, resistive and/or active component elements has been shown to improve the effectiveness of the pulse. For example, increasing the length of the discharge current pulse with the resistor R110 (e.g., 1000 ohms) produces a statistically significant increase in the number of malfunctioning shunts that are rendered conductive. As some malfunctioning shunts are not true open circuits but rather comprise a high resistance which inhibits charging of the capacitor C110, the addition of a spark gap in series with the resistor R110 allows full charging of the capacitor C110 before current is delivered to the light string.

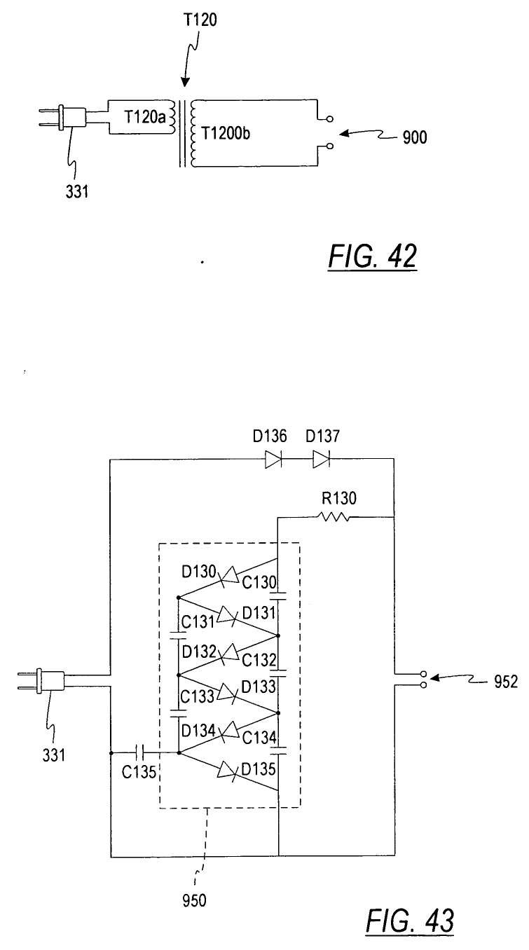

FIG. 42 illustrates a circuit that uses the reactance of a transformer T120 to limit current from an AC power source to safe values (about 10 to 30 mA) and cause breakdown of and subsequent shorting of a malfunctioning shunt by virtue of the voltage and current applied over several AC line cycles. The transformer windings T120a and T120b are chosen to form a step-up transformer that applies a higher-than-rated voltage to a light string plugged into a socket 900, to cause the malfunctioning shunt to conduct. The exact duration and peak current and other characteristics of the high voltage can vary widely and still accomplish the same function.

FIG. 43 depicts the use of a conventional Cockroft-Walton voltage multiplier array in another AC line-operated configuration for repairing a malfunctioning shunt in a light string plugged into a socket. The three-stage multiplier 950, formed by diodes D130-D135 and capacitors C130-C135 and connected to the AC source boosts the voltage to about 900-1000 volts, and discharges through a resistor R130 when the breakdown voltage of the malfunctioning shunt is reached. Connected between the AC source and a socket 952 for receiving the plug of the light string, is a pair of diodes D136 and D137 that are reverse biased (and therefore non-conductive) by the high voltage DC, but conduct on positive half cycles of the AC line voltage to immediately illuminate the string of lights dimly once the initial breakdown occurs, thus giving the operator fast feedback on the success of the repair procedure.

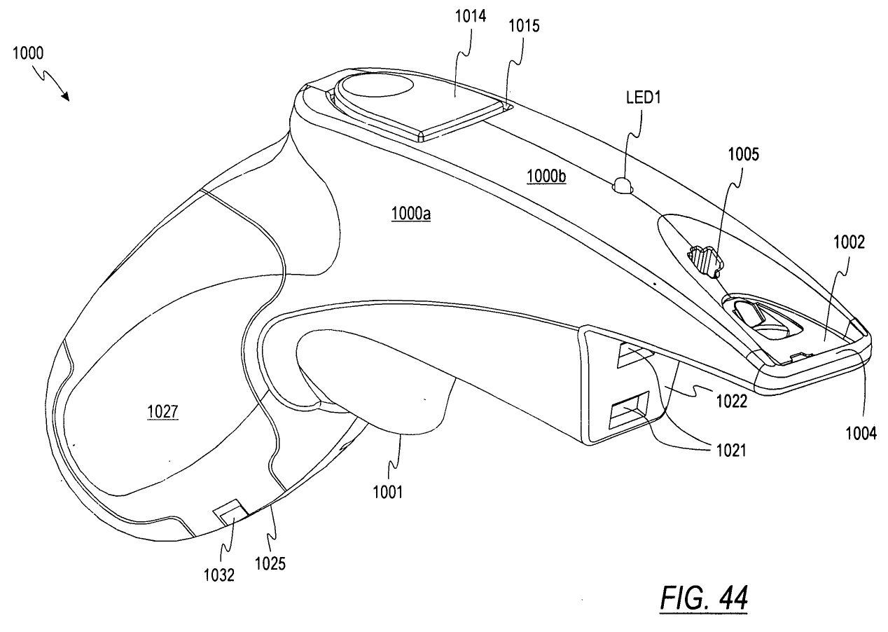

Another preferred embodiment of the invention is illustrated in FIGS. 44-52. In this embodiment the overall shape of the housing has been modified to form a generally L-shaped body 1000 resembling the profile of a futuristic handgun. In the illustrative embodiment, the body 1000 is made in three molded plastic parts 1000a-1000c fastened together by a few détente latches and screw sockets molded as integral parts of the interior surfaces of the body parts, and screws threaded onto the molded sockets.

The trigger 1001 protrudes from the housing 1000, having no obstructions on the free side 1001a of the trigger 1001 in order to give the user easy access. A metal bulb pulling tool 1002 is located at the top of the housing 1000 in front of the trigger 1001 and inside a wire loop 1003 which forms the probe P of the circuit. A plastic cover 1004 formed by the housing 1000 encases the wire loop 1003 and forms a guard extending along and slightly spaced from the leading edge of the bulb pulling tool 1002 to protect the user from the sharp edges on the tool.

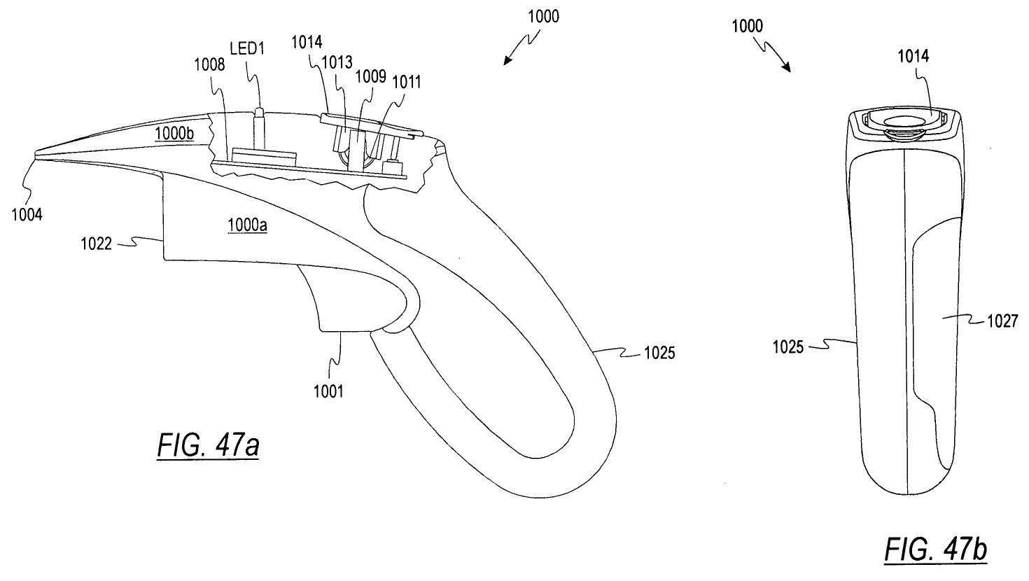

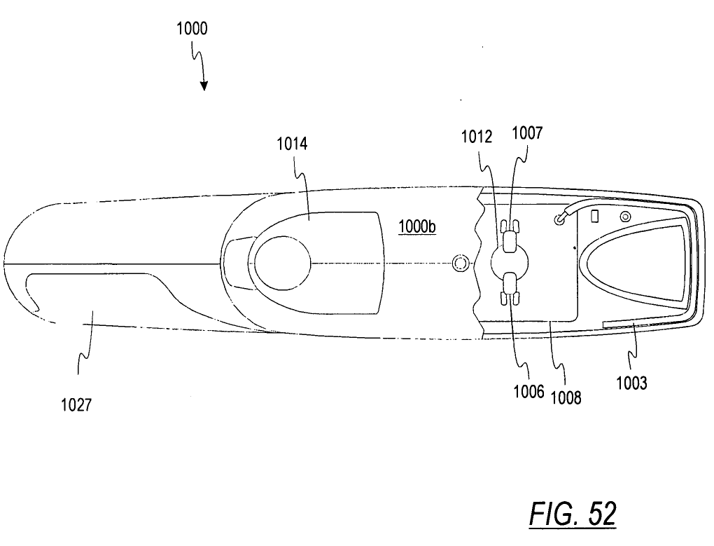

A bulb-testing socket is formed by a hole 1005 in the top wall of the housing 1000, directly behind the bulb pulling tool 1002, and a pair of spring contacts 1006 and 1007 mounted on a printed circuit board (PCB) 1008 directly beneath the hole 1005. To accommodate light bulbs with long bases, an aperture 1012 (see FIG. 52) is formed in the PCB 1008 between the two spring contacts 1006 and 1007. The contacts 1006 and 1007 are connected via the PCB 1008 to a second pair of spring contacts 1009 and 1010 mounted on the PCB 1008 for receiving a battery 1011 (see FIG. 47a) or stack of batteries. When a bulb base is inserted through the hole 1005 into the space between the contacts 1006 and 1007, the bulb is connected to the battery B, causing the bulb to illuminate if it is a good bulb.

To facilitate battery replacement, the battery B is housed in a cavity 1013 formed as an integral part of a molded plastic element 1014 inserted in an opening 1015 at the handle end of the top wall of the housing 1000 (see FIGS. 47a and 50). The element 1014 serves as a combined removable battery holder and manually operable switch actuator. The ends of the battery B are exposed at opposite ends of the cavity 1013 to engage the spring contacts 1009 and 1010 when the element 1014 is inserted into the opening 1015. A lug 1016 depending from a flexible actuator 1017 formed as an integral part of the rear portion of the element 1014 engages a switch S1 mounted at the rear edge of the PCB 1008 and forming part of a manually actuated battery test circuit. When the actuator 1017 is pressed downwardly, it closes the switch S1 to illuminate the LED1 mounted on the PCB 1008 and extending upwardly through an aperture in the top wall of the housing 1000, indicating that a good battery is in place and the device is ready to operate. A latch 1018 on the front edge of the element 1014 mates with an aperture 1018a in the opposed wall of the housing to hold the element 1014 in place in the housing 1000.

All the other elements of the field-detecting and signaling circuit of FIG. 36a, except the buzzer 53, are mounted on the PCB 1008, which is captured in the housing 1000 above a longitudinal septum 1019. A pair of wire leads 53a and 53b connect the PCB 1008 to the buzzer 53 mounted in the interior of the cover 1004. The piezoelectric pulse generator 1020 is mounted beneath the septum 1019, so that the septum shields the PCB and its circuitry from any arcs that might be produced by the piezoelectric device 1020 if the trigger 1001 is pulled when no light string is plugged into the housing 1000. An electrical receptacle 1021 for receiving the prongs of the plug on a light string is formed in the lower front wall 1022 of the housing 1000, below and to the rear of the tool 1002. A pair of metal sockets 1023 and 1024 receive the two prongs of the plug, and the two sockets 1023 and 1024 are connected to opposite sides of the piezoelectric pulse generator 1020. The trigger 1001 is mounted for reciprocating sliding movement in the housing 1000 directly beneath the piezoelectric device 1020 and in direct engagement with the movable striker of the piezoelectric device. The internal return spring in the piezoelectric device 1020 serves to return the trigger 1001 to its advanced position after every pull of the trigger.

In the preferred embodiment, the piezoelectric device 1020 comprises two piezoelectric pulse generators connected in parallel with each other. Both generators are actuated in tandem by the same trigger 1001.

The handle 1025 of the housing 1000 forms a storage area 1026 that is conveniently divided into three compartments 1026a-c for separate storage of fuses and different types of bulbs. The storage compartments are covered by a removable lid 1027 which has a pair of rigid hooks 1028 and 1029 on its upper edge for engaging mating lugs 1030 and 1031 on the wall of the central compartment 1026b. The opposite edge of the lid 1027 forms a flexible latch 1032 that releasably engages mating lugs 1033 on the wall of the central compartment 1026b.

FIG. 55 is another schematic diagram of a power supply for converting a standard 120-volt, 60-Hz input at terminals 2161, 2162 into a 24-volt AC output at terminals 2163, 2164 and 2165, 2166. This circuit uses a switching power supply to deliver a low-voltage, high-frequency PAM signal while also providing the following features for the light strings:
continuous dimming capability from very low light level to full light level,
multi-level dimming capability,
energy-saving and minimum-light-setting features,
soft-start feature to increase the lamp life,
soft start feature to reduce inrush current in the circuit, and
low cost with multi-feature lighting.

The AC input from the terminals 2161, 2162 is supplied through a fuse FH1 to a diode bridge DB2021 consisting of four diodes to produce a full-wave rectified output across buses 2167 and 2168, leading to a pair of capacitors C2023 and C2024 and a corresponding pair of transistors Q2021 and Q2022 forming a half bridge. The input to the diode bridge DB2021 includes a passive component network consisting of C2003, C2004, C2006, C2007, L2001, L2004 and RV2001 which are part of the radio frequency interference and line noise filtering circuitry. Capacitors C2025 and C2026 are connected in parallel with capacitors C2023 and C2024, respectively, to provide increased ripple current rating and high-frequency performance. The capacitors C2023 and C2024 may be electrolytic capacitors while capacitors C2025 and C2026 are film-type capacitors offering high-frequency characteristics to the parallel combination.

The capacitors C2023, C2024 form a virtual center tap. One end of the primary winding Tₚ of an output transformer T2022 is connected to a point between the two capacitors. The secondary winding T_{S} of the transformer T2022 is connected to the output terminals 2163, 2164 and 2165, 2166, through series inductors L2002 and L2003 (along with C2014, C2015, C2016 and R2016) which act as filters to minimize electromagnetic interference. The output terminals receive one or more plugs on the ends of light strings.

An integrated circuit driver U2001, such as a IR21571D controller available from International Rectifier, controls the switching frequency of oscillation and other features indicated above. The power supply V_{cc} for the driver U2001 is derived from the DC bus through a resistors R2001 and R2002 to an internal zener diode. The device includes protection elements which prohibit starting oscillation (operation) until the power supply voltages are in tolerance and if there is a fault which interferes with the proper sequencing of voltages V_{DC}, V_{CC}, and V_{SD}. Diodes D2002, D2003, D2004 and capacitors C2009, C2010 and C2011 provide a boot-strap mechanism for powering the IC. C2012 and C2018 provide bulk storage to start the controller at power up.

The frequency of oscillation of the controller is determined by the total resistance connected to ground from pin 2004 of the controller U2001 and a capacitor C2013 connected across pin 2006 and ground of the controller U2001. The two outputs of the U2001 pins 2011 and 2016 are connected to the gates of the MOSFETs Q2021 and Q2022. A resistor R2008 limits the gate current of the MOSFET Q2021. A resistor R2015 limits the gate current of the MOSFET Q2022.

When power is applied to the circuit, the voltage developed on the bus 2167 causes voltage to be applied to U2001 V_{CC}, V_{DC}, and V_{SD}. This causes the U2001 to start oscillating and start driving the half-bridge transistors Q2021 and Q2022 alternately. This applies voltage across the primary winding T_{P} of the transformer T2021, which in turn applies voltage across the secondary winding T_{S} of the transformer, which is applied to the load.

The rectified output of the DC bus 2167 is applied to the Vcc and V_{DC} pins of the controller U2001 through resistors R2001 and R2002. An internal zener diode and capacitors C2018 and C2012 maintain the operating voltages for the controller. A voltage divider consisting of a thermistor TH2001 and R2005 set the value V_{SD}. The controller uses these three voltages to determine the state of the power bus 2167 to prevent operation when the power bus has collapsed.

The preset output voltage is set by the turns ratio of the output transformer T2022. A limited dimming control is achieved by adjusting the resistance that appears between pins 2006 and 2007 of controller U2001. This resistance controls the amount of dead time for the output FETs which reduces the RMS value of the output voltage of T2002 and thereby reducing the intensity of the light strings connected to terminals 2163, 2164 and 2165, 2166

The dimming feature can be used to provide different fixed light levels, such as a low light output, an energy-saving output, or a full-light output. These three light levels can be achieved by use of three fixed resistors in place of the potentiometer R2014. The three resistor settings can be selected by use of a three-position switch. A low-light output corresponds to a maximum output dead time, and a full-light output corresponds to minimum dead time. An energy-saving output corresponds to an intermediate light level such as a 75% light output.

The controller has an additional control pin (SD) which can be used as a thermal shutdown control to protect the power supply from overheating. As the air temperature in the unit rises, the value of TH2001 will decline until the voltage appearing at pin 2009 of U2001 rises above the shut down value of approximately 2.0 volts.

The particular embodiment illustrated in FIG. 55 is a half bridge circuit as an example but it will be understood that the features of this circuit can be incorporated in other topologies such as flyback, forward, cuk, full bridge or other power converters, including isolated as well as non-isolated power converter designs.

1. A string of decorative lights comprising
a power supply having an input adapted for connection to a standard residential electrical power outlet, said power supply including circuitry for converting the standard residential voltage to a low-voltage output,
a pair of conductors connected to the output of said power supply for supplying said low-voltage output to multiple decorative lights, and
multiple lights connected to said conductors along the lengths thereof, each of said lights, or groups of said lights, being connected in parallel across said conductors.

2. A string of decorative lights as set forth in claim 1 wherein each of said lights is about a half-watt bulb.

3. A string of decorative lights as set forth in claim 1 wherein each of said lights requires a voltage or about 6 volts or less

4. A string of decorative lights as set forth in claim 1 wherein said lights are connected in parallel across said conductors in parallel groups of two to five lights per group, the lights within each group being connected in series.

5. A string of decorative lights as set forth in claim 1 wherein said standard residential voltage is 120 volts and approximately 100 6-volt lights are connected to said conductors.

6. A string of decorative lights as set forth in claim 1 wherein said low-voltage output is DC.

7. A string of decorative lights as set forth in claim 1 wherein said low-voltage output is AC.

8. A string of decorative lights as set forth in claim 1 wherein said low-voltage output is less than about 30 volts.

9. A string of decorative lights as set forth in claim 1 wherein said power supply comprises an electronic transformer.

10. A string of decorative lights as set forth in claim 1 wherein said power supply comprises a switching power supply.

11. A string of decorative lights as set forth in claim 1 wherein said power supply converts the standard residential frequency to a higher frequency output.

12. A string of decorative lights as set forth in claim 11 wherein said higher frequency is in the range from about 10 KHz to about 150 KHz.

13. A string of decorative lights as set forth in claim 1 wherein said conductors are connected to a fixed number of said lights so as to provide a fixed load on said power supply.

14. A string of decorative lights as set forth in claim 1 wherein each of said lights includes means for shunting the light in response to a failure of the light.

15. A decorative lighting system, said system comprising
a power supply having an input adapted for connection to a standard residential electrical power outlet, said power supply including circuitry for converting the standard residential voltage to a low-voltage output,
a plurality of pairs of conductors connected to the output of said power supply for supplying said low-voltage output to multiple sets of decorative lights, and
multiple lights connected to each pair of said conductors along the lengths thereof, each of said lights, or groups of said lights, being connected in parallel across each of said pairs of conductors.

16. A decorative lighting system as set forth in claim 15 wherein each of said lights is about a half-watt bulb.

17. A decorative lighting system as set forth in claim 15 wherein each of said lights requires a voltage or about 6 volts or less

18. A decorative lighting system as set forth in claim 15 wherein each of said pairs of conductors has multiple groups of said lights connected in parallel across the conductor pair, each of said parallel groups including two to five lights connected in series within the group.

19. A decorative lighting system as set forth in claim 15 wherein said standard residential voltage is 120 volts and approximately 100 6-volt lights are connected to each of said pairs of conductors.

20. A decorative lighting system as set forth in claim 15 wherein said low-voltage output is DC.

21. A decorative lighting system as set forth in claim 15 wherein said low-voltage output is AC.

22. A decorative lighting system as set forth in claim 15 wherein said low-voltage output is less than about 30 volts.

23. A decorative lighting system as set forth in claim 15 wherein said power supply comprises an electronic transformer.

24. A decorative lighting system as set forth in claim 15 wherein said power supply comprises a switching power supply.

25. A decorative lighting system as set forth in claim 15 wherein said power supply converts the standard residential frequency to a higher frequency output.

26. A decorative lighting system as set forth in claim 25 wherein said higher frequency is in the range from about 10 KHz to about 150 KHz.

27. A decorative lighting system as set forth in claim 15 wherein each of said pairs of conductors is connected to a fixed number of said lights so as to provide a fixed load on said power supply.

28. A decorative lighting system as set forth in claim 15 wherein each of said lights includes means for shunting the light in response to a failure of the light.

29. A method of powering a string of decorative lights, said method comprising
converting a standard residential electrical voltage to a low-voltage, and
supplying said low-voltage to a pair of parallel conductors having multiple decorative lights connected to said conductors along the lengths thereof, each of said lights, or groups of said lights, being connected in parallel across said conductors.

30. A method of powering a string of decorative lights as set forth in claim 29 wherein each of said lights is about a half-watt bulb.

31. A method of powering a string of decorative lights as set forth in claim 29 wherein each of said lights requires a voltage or about 6 volts or less

32. A method of powering a string of decorative lights as set forth in claim 29 wherein said lights are connected in parallel across said conductors in parallel groups of two to five lights per group.

33. A method of powering a string of decorative lights as set forth in claim 29 wherein said standard residential voltage is 120 volts and approximately 100 6-volt lights are connected to said conductors.

34. A method of powering a string of decorative lights as set forth in claim 29 wherein said low-voltage output is DC.

35. A method of powering a string of decorative lights as set forth in claim 29 wherein said low-voltage output is AC.

36. A method of powering a string of decorative lights as set forth in claim 29 wherein said low-voltage output is less than about 30 volts.

37. A method of powering a string of decorative lights as set forth in claim 29 wherein an electronic transformer is used in the conversion of said standard residential electrical voltage to a low voltage.

38. A method of powering a string of decorative lights as set forth in claim 29 wherein a switching power supply is used in the conversion of said standard residential electrical voltage to a low voltage.

39. A method of powering a string of decorative lights as set forth in claim 29 wherein the standard residential frequency is converted to a higher frequency output.

40. A method of powering a string of decorative lights as set forth in claim 39 wherein said higher frequency is in the range from about 10 KHz to about 150 KHz.

41. A method of powering a string of decorative lights as set forth in claim 29 wherein a fixed load is maintained on said conductors by limiting the number of lights connected to said conductors to a fixed number.

42. A method of powering a string of decorative lights as set forth in claim 29 which includes the step of shunting each of said lights in response to a failure of that light.

43. A string of decorative lights comprising:
a plurality of elongated electrical conductors having multiple electrical lamps connected thereto at intervals along the lengths of the conductors,
a small storage compartment for storing spare components for use in said string of decorative lights, a movable closure for opening said storage compartment to permit access to the spare components stored therein, and for closing the compartment during storage of the spare components, and
means for attaching said storage compartment to said string of decorative lights so that the spare components stored therein are conveniently accessible when needed to replace a component in said light string.

44. The decorative light string of claim 43 which includes a plug or receptacle on at least one end of said string, and said storage compartment is attached to said light string by being formed as a part of said plug or receptacle.

45. The decorative light string of claim 43 which includes a receptacle on at least one end of said string, and said storage compartment is attached to said light string by prongs projecting from an exterior surface of said storage compartment and positioned and dimensioned to fit into said receptacle.

46. The decorative light string of claim 43 wherein said storage compartment is divided into sub-compartments for segregated storage of different components.

47. The decorative light string of claim 43 wherein said movable closure includes a cover and a hinge connecting said cover to said storage compartment to allow the cover to pivot about the hinge to selectively open and close the compartment.

48. The decorative light string of claim 43 further comprising locking means for selectively maintaining said movable closure in a closed position.

49. The decorative light string of claim 43 wherein said storage compartment includes at least two opposite interconnected walls forming channels adapted to slidably receive said movable closure for opening and closing said compartment.

50. The decorative light string of claim 43 wherein said storage compartment includes a wall forming a first opening adapted to receive in frictional engagement a base of an electrical lamp, to assist in removing the electrical lamp from a socket.

51. The decorative light string of claim 50 wherein said movable closure includes a domed portion defining a second opening aligned with said first opening to receive the base of the electrical lamp in frictional engagement to assist in removing the electrical lamp from a socket.

52. The decorative light string of claim 50 further comprising means to cover said first opening when no bulb is placed therein for removal.

53. The decorative light string of claim 51 further comprising means to cover both said first and second openings when no bulb is placed therein for removal.

54. A method of storing spare components for use in a string of decorative lights, said method comprising:
placing said spare components in a small storage compartment having a movable closure for opening the compartment to permit access to the spare components stored therein, and for closing the compartment during storage of the spare components, and
attaching said storage compartment to said string of decorative lights so that the spare components stored therein are conveniently accessible when needed to replace a component in said light string.

55. The method of claim 54 wherein said light string includes a plug or receptacle on at least one end of the string, and said storage compartment is attached to said light string by being formed as a part of said plug or receptacle.

56. The method of claim 54 wherein said light string includes a receptacle on at least one end of the string, and said storage compartment is attached to said light string by prongs projecting from an exterior surface of said storage compartment and positioned and dimensioned to fit into said receptacle.

57. The method of claim 54 wherein said storage compartment is divided into sub-compartments for segregated storage of different components, and said different components are placed in different ones of said sub-compartments.
